(19) United States
(12) Patent Application Publication
(10) Pub. No.: US 2007/0026371 A1
(43) Pub. Date: Feb. 1, 2007

(54) Personal electronic text library system patent

(76) Inventor: Beryl Wood, Calgary (CA)

Correspondence Address: Beryl Wood, RPO Glenmore Landing, Box # 72081, Calgary, AB, T2V 5H9, CA

(21) Appl. No.: 11/108,596

(22) Filed: Aug. 1, 2005

(51) Int. Cl. G09B 5/00

(52) U.S. Cl. 434/317

(57) ABSTRACT

The Personal Electronic Text Library System [PETLS] invention is a means for the collection, storage and distribution of text book and/or printed material in electronic format protected against unauthorized duplication according to the proprietary PETLS Protection Standard. Said protection applies to text book and/or printed material in electronic format originating from a plurality of sources of said material transferred into PETLS, the storage of said material within PETLS, the transfer of copies of said material to portable physical media through a plurality of points of access and the display of said material from said portable physical media on dedicated PETLS display devices, the B-Books. Text book and/or printed material in electronic format stored on the portable PETLS Electronic Storage Media being protected against unauthorized duplication can be purchased and/or shared and/or lent and/or traded and/or donated between any and/or all individuals and/or users of the B-Book dedicated display devices.

### BACKGROUND OF THE INVENTION

1. Field of the Invention

The present invention relates to information collection and data storage and data distribution and display systems

and specifically to the display of text book and/or printed material on portable dedicated display devices, and downloadable printed material.

2. Description of the Prior Art

Vast amounts of text book and/or printed material are widely distributed in the form of printed books, other information publications, and other printed material. These traditional materials are printed on paper with a page printed on each side of the paper so that when reading a book, magazine, newspaper, or other printed material, one or two pages of printed material are exposed to the reader. These printed materials consume vast quantities of paper and also shipping resources to transport them from publishers to bookstores and/or other stores for sale to the ultimate consumer, to libraries, to warehouses for storage, or to other points of distribution.

With the availability of book-like material displayed in page format on the PC, consumers have shown a much higher acceptance level to read books and literature from a computer screen (Example: Internet access for information, and reading that information from display screens is growing exponentially). Readers however want to hold the item they are reading in their preferred reading position, look down at their reading material, view pages one by one, being able to move through the material and search the material in a manner similar to that of paper printed material.

Publishers spend millions of dollars a year producing electronic editions of their publications for their internal use. Consumers desire electronic devices that can display such electronic versions of printed publications that are affordable, lightweight and book-like with advanced search and retrieval modes common in personal computer applications software. As yet, there have been failures to deliver a personal, dedicated electronic device that is as easy to use or even as desirable to use as the common book, printed on paper and bound in a soft or hard cover.

The present invention provides a personal, portable dedicated display device that provides these features while implementing protection the electronic versions of text book and/or printed material against unauthorized duplication and at a price point that would make it commonplace, like the cell phone.

Further, the present invention provides the support infrastructure for the collection and storage of electronic versions of text book and/or printed material from a multitude of publishers and/or other sources and the sale and distribution of said material to consumers and/or users of said material.

The prior art, which may be relevant to this invention, is described hereinafter.
1. U.S. Pat. No. 4,159,417 to Rubincam discloses a portable, battery powered electronic viewer that reads and displays data stored in a holographic memory card. The memory can be page oriented so that each hologram represents a page in a textbook and the entire textbook can be stored on one card. An alternative embodiment provides a text book-sized container hinged like a textbook so that 2 opposing displays can be read in a manner similar to the reading of a textbook. The device incorporates controls for controlling pagination, for adjusting the speed of leafing through the textbook and for displaying and entering page numbers. This disclosure describes facing displays mounted in a hinged text book-sized device with plug-in memory card storage for a single textbook and functions that provide page control.
2. U.S. Pat. No. 4,545,023 to Mizzi discloses a handheld, battery-powered computer comprising various electronic cards and a flat touch screen. The touch screen eliminates the need for a keyboard or other input keypads. The screen can display alphanumeric characters and graphics. Any area touched on the screen is identified by its coordinates. The device can be connected to a remote RAT via an acoustic coupler and a telephone line. The device can be adapted for particular uses such as handwriting recognition or TV or radio receiving by plugging in special purpose electronic cards. This disclosure describes a battery-powered, handheld computer that uses a large, flat touch screen display to replace a mechanical keyboard and that has the facilities to communicate with a remote host over telephone lines.
3. U.S. Pat. No. 4,649,499 to Sutton et al. discloses computer programs designed to emulate a three dimensional object such as a rotary card file or a hand calculator on a computer touch screen. Functions are performed by touching appropriate symbols on the touch screen, for example, a knob to rotate the cards, a tab label to select and view a card, plus soft keys to perform other functions on the cards. An emulation that puts up a functional calculator touch screen display is also disclosed. This disclosure describes the interaction between a touch screen and the operation of a computer and software to present a display of information with soft key areas that are used to provide user control of the associated information or function.
4. U.S. Pat. No. 4,682,161 to Bugg discloses a video display terminal connected via a modem over a telephone line to a remote source for the purpose of acquiring and transmitting information. This disclosure describes the logic circuits used to transfer digital codes to the terminal so that the data can be displayed on a raster scan display device in either normal of enlarged character size. This disclosure describes communicating over a telephone line via modem and transferring data to be displayed on a screen.
5. U.S. Pat. No. 4,855,725 to Fernandez discloses a simulated textbook that uses a battery-powered microprocessor with ROM for the program and RAM storage for data and a large LCD screen to display up to 2 pages of information transmitted from a CD-ROM equipped PC over an attached infrared transceiver to a transceiver incorporated into the simulated textbook. The textbook uses a touch screen to display the data and to control paging through the material. The device automatically requests additional pages of information to be transmitted from the PC for storage in the textbook. The textbook can be taken with you for latter reading. Data storage is maintained by a battery powered RAM. An alternative version disclosed includes a keypad and a tactile pad switch for inputting requests for a particular page or to page forward or backward. The text book displays a single page at a time with the program automatically requesting pages of information to be transmitted from the PC to the text book on the fly as the user reads or pages through the text book.
6. U.S. Pat. No. 4,918,632 to York discloses a battery-powered, portable touch screen computer designed with a multitude of holes along one edge so that the computer can be transported in a 3-ring binder or the like.
7. U.S. Pat. No. 5,031,119 to Dulaney et al. discloses a handheld, keyboard less computer with a split liquid crystal display (LCD) screen, the top half of the screen displays an application and the bottom half displays a keyboard. A glass overlay with an electrically-conductive coating interacts with an electrically conductive pen so that the user can input keystrokes on the bottom half of the screen or use the pen to perform mouse-like functions on the top half.
8. U.S. Pat. No. 5,109,354 to Yamashita et al. discloses a portable pocket textbook device comprising a touch screen or pressure sensitive LCD display, a cursor, function keys and an on/off switch that is activated when the pocket-text book device is opened. A hinged binding contains a battery pack and rings to hold expansion cards. A back cover contains the electronics and a power source. Multiple methods of communicating between the expansion cards and the pocket-text book include fibre optics, LED links and electromagnetic induction along the rings. The screen can be touch sensitive or the unit can be set-up with a pressure sensitive screen for hand writing recognition. The expansion cards provide the capability of adding and removing a plurality of databases.
9. U.S. Pat. No. 5,339,091 to Yamazaki et al. discloses a portable electronic text book comprised of a LCD display, key-button inputs or other external input facilities, an on/off switch activated by opening the cover, a hinged cover, a solar cell in the cover to power the unit, a connector for an external power source and a disk drive to read information from optical or floppy disks. Other memory devices could include magnetic tape and EPROMS. The screen incorporates pressure or photo sensors so the user can select and emphasize portions of the text for latter recall.
10. U.S. Pat. No. 5,379,057 to Clough et al. discloses a portable, self-contained general-purpose, keyboard less computer that uses a touch screen display for data entry. The touch screen is superimposed over a colour-graphics LCD-type display. The computer includes memory to store a data collection application and libraries of possible user responses for display in text or pictogram form. The user then touches the area displaying the text or pictogram to select the proper response. The disclosed computer is battery or AC powered and equipped with a serial I/O communications port for connecting to a modem or for other serial communications to a host computer. The portable computer communicates with the RAT to download selected applications and associated libraries. The user can also enter information to identify the user and to personalize the database created.
11. U.S. Pat. No. 5,663,748 to Huffman et al An electronic book includes a book-shaped housing having a first housing member pivotably connected to a second housing member to open and close in a book-like manner. A touch screen displays a page of the text represented by the machine-readable data. A user-initiated event selecting a portion of the text is received by the touch screen. The touch screen displays the portion of the text in a highlighted form. The processor stores an indicator of the portion of the text to be highlighted in the removable machine-readable storage medium to remain with the text when the removable machine-readable storage medium is removed from the electronic book.
12. U.S. Pat. No. 5,761,485 to Munyan et al. disclose a Personal Electronic Book System invention replaces a standard handheld book with an electronic equivalent. The invention is sized and configured to be book size and to open like a book for use. When opened, the user sees two facing page-like touch-sensitive, display screens with black print on white background. Icons represent the electronically stored material, “artwork, audio clips, books, E-mail, faxes, games, magazines, movies, musical compositions, newspapers, photographs, software, video clips, etc.”, which are selected by touching the icon. When a book, magazine, newspaper, or the like is selected, its table of contents is displayed and the user can then read page by page or go directly to a particular page by touching the selection listed in the table of contents. Closing the Personal Electronic Book automatically shuts down the device. Touching a page number before closing the Personal Electronic Book inserts a bookmark so that when the Personal Electronic Book is re-opened, the user is returned to the same page. New printed or multimedia material can be downloaded from a remote server, that is, “a bookstore,” and old material, books read, etc., can be deleted to make room for the new material.
13. U.S. Pat. No. 5,772,446 Rosen et al. disclose an interactive learning system is disclosed that includes a note-making facility, a mentor facility, and an editor facility as its major subsystems. The note-making facility allows the user to create notes while scanning through an electronic text file that is accessible from a suitable memory space. The mentor facility provides content-specific information in response to the selection of certain passages or quotations from the text file by the user. The editor facility provides generalized learning strategies and recommendations useful in the analysis of text and the preparation of a written report. The information provided by the editor facility is generalized, and hence is not specific to the current text file; in contrast, the mentor facility is content-specific, and furnishes the user with information that is specifically related to the text under review.
14. U.S. Pat. No. 5,847,698 to Reavey, et al. An electronic book device has an electronic display unit having a flat panel screen and a housing for containing the flat panel screen. A cover is provided, which is hinged and electrically connected to the electronic display unit. The housing further has a means for accessing material on a PC card and forwarding the material to the electronic display unit. The housing also has navigation keys for navigation through the material. Activation and deactivation of the electronic display unit is responsive to opening, partially opening and closing of the electronic book device. The device features a means for orientating the material on the electronic display unit responsive to an opening position of the electronic book device. In another embodiment, a data entry mechanism is operatively connected to the electronic display unit. The data entry mechanism can be implemented by using a touch screen for the electronic display unit. In still another embodiment, a second electronic display unit replaces the cover.
15. U.S. Pat. No. 5,956,034 Sachs, et al. discloses an electronic publication publishing and distribution system is provided for dissemination of written materials that can be read on a portable electronic book. A RAT contains an inventory of written materials in electronic form that can be selected and then downloaded into the portable electronic book's memory. The RAT keeps track of the transactions, and encodes the data prior to downloading, using an encryption system involving a security number that is unique to the portable electronic book. The encrypted data cannot be decrypted until it is resident in the memory of the portable electronic book. Upon receipt of the encrypted data, the portable electronic book decrypts the data, and can display the text of the original material on its display screen. The portable electronic book has a central processing unit with an operating system for controlling the functions of the portable electronic book. There is non-volatile electronic memory storage for retaining publications in the portable electronic book. A plurality of electronic keys is provided in the portable electronic book that corresponds to graphical representations such as icons on the portable electronic book display adjacent to each key
16. U.S. Pat. No. 5,956,048 to Gaston; Kerry R. An electronic book system including a portable display unit and a mated downloading stand which receives the unit in a plug-in manner so that data and power ports of the unit matably connected with respective data and power connectors of the stand. Upon insertion, data is downloaded to a memory in the unit when a data signal is supplied through the data port. The display device has a tabular shaped housing with a display screen and control buttons applied to a front planar surface of the housing. The stand is modularly designed to be stacked adjacently with additional like stands in mated connection with each other for common data and power communication. A system for preventing unauthorized use of stored book data is also provided wherein each unit is assigned a unique electronic code value, and wherein the book data on a particular storage medium may be initially accessed by any coded unit, but wherein subsequent access by other units is denied.
17. U.S. Pat. No. 6,075,968 Morris et al. disclose a system for educating learning disabled students includes a work station accessible by students and teachers for converting information between paper-written and computer character-recognized formats, whereby a teacher or a student can convert paper-written information such as assignments into a computer character-recognized format. The system further includes a plurality of student set-ups, each of which permits the exchange of computer character-recognized information with the workstation. Each student set-up presents computer character-recognized information to a student both audibly and visually in a synchronized manner to permit the student to acquire knowledge, understand assignments and produce work products in a computer character-recognized format that can be converted to a paper-written format at the work station for submission to the teacher. A student support network provides the student with supplemental information and guidance as needed to obtain a quality education.
18. U.S. Pat. No. 6,154,214 Uyehara et al. disclose an electronic reading system is disclosed which allows users to download books and/or other types of content to a hand-held reader device for viewing. Using software, which runs on a personal computer (PC), the user can download titles from Internet sites to the PC. Titles are then automatically transferred to the device when the device is placed in a cradle, which is connected to the PC. Using the device's touch-sensitive display and graphical user interface, the user can access various software-implemented features associated with the display and management of the content. One feature is a user-definable hotkey that can be “dragged and dropped” onto a menu item to create a shortcut to that item. Another feature allows the user to tap twice on a displayed word to cause the device to look the word up in a pre-specified or default reference title, such as a dictionary or an encyclopaedia. Another feature allows the user to block a passage on the touch-sensitive display and then specify one or more destinations (email addresses, file folders, fax numbers, printers, etc.) for routing the passage; when the device is subsequently placed in the cradle, the passage is automatically retrieved by the PC and routed to the specified destination(s). The device also implements a user interface feature for allowing the user to rapidly and conveniently adjusts the orientation of the displayed title.
19 U.S. Pat. No. 6,198,904 to Rosen et al. disclose an interactive learning system is disclosed that includes a note-making facility, a mentor facility, and an editor facility as its major subsystems. The note-making facility allows the user to create notes while scanning through an electronic text file that is accessible from a suitable memory space. The mentor facility provides content-specific information in response to the selection of certain passages or quotations from the text file by the user. The editor facility provides generalized learning strategies and recommendations useful in the analysis of text and the preparation of a written report. The information provided by the editor facility is generalized, and hence is not specific to the current text file; in contrast, the mentor facility is content-specific, and furnishes the user with information that is specifically related to the text under review.
20. U.S. Pat. No. 6,313,828 to Chombo; Carlos Landetta. disclose This invention relates to an electronic book comprising a structure capable of being spreaded into two sections, connected to each other by means of assembly element of the hinge type, which provides the controlled movement of said two sections upon said assembly element; to provide for the opening and closing of said electronic book; and also to provide for the passage of the several analogic and digital interconnection elements required to interconnect the components of the hardware model.
21. U.S. Pat. No. 6,704,733 to Clark; George Philip et al discloses In general, in one aspect, the disclosure describes a method of processing content for distribution over a computer network. The method includes receiving submitted electronic content, accessing identification of at least one of a set of more than one electronic book digital rights management (DRM) systems, and automatically generating an electronic book from the received electronic content for distribution in accordance with the identified electronic book digital rights management system(s).
22. U.S. Pat. No. 6,842,333 to Lee; Chang-II et al disclose A portable electronic device includes a main board fixed inside a case that mounts various circuit parts, an LCD module positioned at an upper side of the main board that has an LCD, an internal frame and a touch screen and an LCD module connecting unit installed for electronic connection between the main board and the LCD module when the main board and the LCD module are mutually combined or assembled. Since the main board connector is installed at the main board and the LCD connector is mounted at one side of the LCD module, when the LCD module is assembled at the main board, the LCD connector and the main board connector are mutually connected. Thus, no electric connection work is necessary, and thus, its assembling is simple and assembly process can be shortened. Further, the LCD module-connecting unit can directly connect the main board and the LCD module through a support member therebetween that can include a heat sink for the main board.
23. U.S. Pat. No. 6,874,009 to Tuli; The invention discloses a portable device that allows the user to access the Internet and World Wide Web. The portable device includes a modem that connects to a cellular telephone, thus the portable device connects wirelessly to the Internet. A RAT that may also be a Retail Access Terminal is connected to the Internet and comprises various software programs to translate and compress into bit map or raster images the information received from the Internet. The compressed image is sent the portable device and the device is capable of decompressing the compressed image. Thus, the user views a bit map image of a Web page. The portable device further comprises methods of pointing and clicking on text and images, which represent links to other pages. All commands that the user enters into the portable device are sent to the host computer, which performs the commands via a virtual browser, and sends the information back to the portable device. The user may also be charged fees for the purchase of the device as well as monthly fees for the usage
24. U.S. Pat. No. 6,895,503 to Tadayon, et al. discloses a Digital rights management allows one or more of usage rights and delegation rights to be associated with a document. Through the use of the usage rights and the delegation rights, a hierarchy of rights associated with a document is created that provides a tree-type structure of rights extending from the content owner down through one or more users.
25. U.S. Pat. No. 6,859,533 to Wang, et al. discloses Methods for transferring among key holders in encoding and cryptographic systems the right to decode and decrypt messages in a way that does not explicitly reveal decoding and decrypting keys used and the original messages. Such methods are more secure and more efficient than typical re-encoding and re-encryption schemes, and are useful in developing such applications as document distribution and long-term file protection.
26. U.S. Pat. No. 6,820,063 to England, et al. discloses Digital rights for content downloaded to a subscriber computer from a provider are specified in an access predicate. The access predicate is compared with a rights manager certificate associated with an entity, such as an application, that wants access to the content. If the rights manager certificate satisfies the access predicate, the entity is allowed access to the content. A license that specifies limitations on the use of the content can also be associated with the content and provided to the entity. The use the entity makes of the content is monitored and terminated if the entity violates the license limitations. In one aspect of the invention, the access predicate and the license are protected from tampering through cryptographic techniques
27. CA 2231807 PCT/US1996/019036 to Munyan, Daniel E. et al. The personal Electronic Book System invention replaces a standard handheld book with an electronic equivalent. The invention is sized and configured to be book size and to open like a book for use. When opened, the user sees two facing page-like touch-sensitive, display screens with black print on white background. Icons represent the electronically stored material, “artwork, audio clips, books, E-mail, faxes, games, magazines, movies, musical compositions, newspapers, photographs, software, video clips, etc.”, which are selected by touching the icon. When a book, magazine, newspaper, or the like is selected, its table of contents is displayed and the user can then read page by page or go directly to a particular page by touching the selection listed in the table of contents. Closing the Personal Electronic Book automatically shuts down the device. Touching a page number before closing the Personal Electronic Book inserts a bookmark so that when the Personal Electronic Book is re-opened, the user is returned to the same page. New printed or multimedia material can be downloaded from a remote server, that is, “a bookstore”, and old material, books read, etc., can be deleted to make room for the new material.
28. CA 2241816 to McMahon, M. James An easily portable electronic book-reading device for reading text information of documents, books etc. previously stored on a storage medium. The device generally comprises a flat screen monitor, a control panel, and a data storage/reading device. The flat screen monitor displays text information of a document being read, and optionally system control data. The control panel allows the user to control the display of information on the monitor, including selection of a document to be read; moving to a desired page; “book-marking” a desired page to allow the user to rapidly return to that page at a later time; stepping forward and backward through a document one page at a time; and controlling the size of text displayed on the monitor. The data storage/reading device, which can conveniently be provided as a CD-ROM or (preferably) a Micro-CD-ROM is provided to read text information from a removable memory medium, for display on the monitor. The flat screen monitor, control panel, and data storage/reading device are housed within a housing designed to facilitate ease and comfort of the user over extended periods of use of the device, and further to effectively protect the various components from damage due to impacts or entry of foreign matter such as dust and sand.
29. CA 2263356 PCT/US1997/014121 to Sachs, James et al. An electronic publishing and distribution system is provided for dissemination of written materials that can be read on a portable electronic book. A RAT (16) contains an inventory that can be selected and then downloaded into the book's memory. The RAT keeps track of the transactions, and encodes the data prior to downloading, using an encryption system (34). The encrypted data cannot be decrypted until it is resident in the memory of the book. Upon receipt of the encrypted data, the book decrypts the data. A plurality of electronic keys is provided corresponding (36, 37) to graphical representations such as icons adjacent to each key.
30. CA 2325134 PCT/US1999/003179 to Uyehara, Lance An electronic reading system (30, 31, 32) allows users to download book and other types of contents to a hand-held reader device for viewing. Using software which runs on a personal computer, the user can download titles form Internet sites to the PC. Titles are then automatically transferred to the device when the device is placed in a cradle, which is connected to the PC. Using the device's touch sensitive display and graphical user interface, the user can access various software implemented features associated with the display and management content.
31. CA 2355713 PCT/GB1999/004219 to Jarman, David Apparatus for displaying electronic format data is disclosed. It is particularly useful for displaying text material, e.g. as an electronic book. The apparatus has a casing with a display means such as a screen, and a data transmission/reception means enabling the apparatus to communicate with a source of data and to download data from the source for subsequent display. The data is encrypted for the download and decrypted within the apparatus to enable it to be displayed in clear. The distinctive feature of the invention is the use as an encryption/decryption key of data stored in addresses of a read only memory within the apparatus. Each time data is downloaded from the source; fresh addresses can be specified by the source, providing encryption/decryption keys for the next download session. This gives a very high degree of security as the keys themselves do not have to be transmitted.
32. Great Britain Patent No. GB 2,149,544A to Crossland et al. discloses an electronic textbook that can display a page of text or illustrations and can increase type size for easier reading by the partially sighted. This device comprises a LCD-type matrix display, a memory unit that holds the material to be displayed, a telecommunications port, a microprocessor controller and a battery power supply and charger. The display has a black on white contrast approaching that of print on paper. Data storage can be a micro cassette mounted on the back of the display unit, a cartridge or disk that plugs into the back of the text book or an external source. The telecommunications port provides the capability to download materials from a central database such as an electronic newspaper or service repair information. User functions include page forward and backward, search for a specific page number, fast rewind, browse forward or backward, split screen for a simultaneous 2-page display and word search. The current page of information can be held in RAM to serve as a text bookmark feature.
33. PCT/US96/14420 WO 97/10541 to Petruzzi, James, et al. An electronic book reader (10) for displaying the contents of a memory device like a compact disk (22) in a page-by-page format. The book reader (10) includes a processor for converting the digitally stored contents of the book to a user-readable format and a display (16, 18) of the book a portion at a time. The book reader (10) also includes controls (24, 26) for displaying pages of the book at a time and turning of pages consecutively. A preferred embodiment of the invention includes a processor that records the last page displayed upon activation of the off switch. The preferred embodiment further includes physical storage for compact discs or other digital storage media.
34. PCT/US98/24361 WO 99/24994 to Gaston, Kerry An electronic book system including a portable display (16) unit and a mated downloading stand (60) which receives the unit in a plug-in manner so that data and ports (32a, 34a) of the unit mutually connected with respective data and power connectors of the stand (132, 134). Upon insertion, data is downloaded to a memory (48) in the unit when a data signal is supplied through the data port. The display device has a tubular shaped housing with a display screen (16) and control buttons applied to a front planar surface of the housing. The stand is modularly designed to be stacked adjacently with additional like stands in mated connection with each other for common data and power communication (32a, 34a). A system for preventing unauthorized use of stored book data is also provided wherein each unit is assigned a unique electronic code value (52), and wherein the book data on a particular storage medium (36) may be initially accessed by any coded unit, but wherein subsequently access by other units is denied.
35. PCT/US96/19704 WO 97/22103 to Huffman, James, R. et al An electronic book includes a book-shaped housing having a first housing member pivotably connected to a second housing member to open and close in a book-like manner. A touch screen displays a page of the text represented by the machine-readable data. A user-initiated event selecting a portion of the text is received by the touch screen. The touch screen displays the portion of the text in a highlighted form. The processor stores an indicator of the portion of the text to be highlighted in the removable machine-readable storage medium to remain with the text when the removable machine-readable storage medium is removed from the electronic book.
36. PCT/MX97/00034 WO 98/21665 to Landetta Chombo, Carlos. The present invention relates to an electronic book which comprises a structure which can be unfolded into two sections which are joined by means of an assembly element of the hinge type which provides for the controlled movement of said two sections with respect to said assembly element to permit the opening and closing of said electronic book as well as the passage of various analog and digital interconnection elements required to interconnect the components of the hardware model.
37. PCT/RU97/00064 WO 98/34184 to Durnitsky, Oleg Vladimirovich The inventive electronic book is designed to permit visualization of significant information volumes displayed in the form of graphic symbols, such information being drawn from a medium directly connected with said electronic book, as well as transmission-reception of information on the global communication channels or the wireless communication channel by using, by means of infrared transmission, the protocols for cellular, radio paging, modem, facsimile or satellite communication, and can also be used as an individual means for reading books, looking up charts and other information and as a means to receive audio information. The electronic book comprises, on the one hand, units for reading and receiving information, the outputs of which are controlled by the data bus of the reproduction control unit, while said unit is controlled through outputs by the display unit and, on the other hand, a radio transmitter/receiver, which is controlled through one output by the data bus of the reproduction control unit. The information receiver unit is designed so as to enable both a mutual exchange of data on the global communication network and identification of the book owner's code. The reproduction control unit includes a monitor, an interface and a control unit, while said monitor consists of a microprocessor connected with both permanent and working storage units and with a control unit. The display unit has a liquid crystal display, and the reproduction control unit is controlled through one of its outputs by the sound signal former. Said book includes a recording unit on the information medium, which is connected to the monitor.
38. PCT/CH99/00084 WO 99/44144 to Heutschi, Theodor The electronic device is provided with a housing, a display, inputting means, a microprocessor, a control unit, a memory, a source of energy and one or more interfaces for exchanging data with a peripheral device. The display is preferably an LCD display and is dimensioned in such a way as to resemble a page of a normal-sized book. The display is also integrated in a flat, frame-shaped housing. The inputting means for the control unit of the device are configured as a touch screen on the display. A station for receiving and transmitting signals over a radio network enables electronic data such as e-mails, telefaxes, Internet data etc. to be exchanged. Said data can then be visualised on the display. The advantages of the inventive electronic device are that it can be configured to be very light and easy to handle, is universal and still has a relatively large display
39. PCT/FR00/00989 WO 00/63784 to Dahan, Michael An electronic book comprising a central processing which includes a memory and which is connected to a display screen and a control interface, whereby the memory of the central processing unit contains at least one document which is comprised of alphanumerical characters and pre-positioned page-break marks which are used to set up a page according to the type of characters selected by a user or in accordance with screen characteristics.
40. PCT International Pat. No. WO 87/01481 to Stein discloses a portable device in the shape of a textbook that reads data via a laser from a credit card sized data card or from other storage media. This electronic textbook has opposing displays, a card reader from which textbook unit is transferred onto the display screens, 2 pages at a time, and a battery or AC power source. The device also incorporates user controls to advance or reverse paginate through the textbook, go to the first page of the textbook and an automatic text bookmark feature. Opening and closing the hinged cover can turn the displays on and off.

The present invention overcomes many of the drawbacks and deficiencies of prior art display devices by providing an easy-to-use, book-like, portable, personal, electronic display device, capable of displaying pages in their native printed format with the text book and/or printed material to be displayed stored on portable physical media in a manner that provides protection of said material against unauthorized duplication.

### OBJECTS AND SUMMARY OF THE INVENTION

The B-Book component of the PETLS invention replaces a standard handheld printed book with an electronic equivalent sized and configured to be book size, or pocket book size, to open like a book for use, to display pages of text book and/or printed material in their original “as printed” format, and to have the look and feel of a printed book.

Another object of the present invention is to protect printed material in electronic format entered into and stored within PETLS, transferred between components of PETLS and ultimately accessed by users of the B-Book display device against unauthorized duplication.

Still another object of the present invention is to maintain the ability to share, lend, trade or donate printed material in electronic format on portable physical media while protecting said material against unauthorized duplication.

An object of the present invention is to provide a portable electronic device that can store many portable physical media containing text book and/or other printed material in electronic format within a single unit.

Another object of the present invention is to provide a collection of text book and/or other printed material in electronic format that requires only a small amount of physical storage space.

Still another object of the present invention is to provide a reusable device that can be used to display an unlimited number of text book and/or other printed materials in electronic format.

Yet another object of the present invention is to provide a display device that would be immediately accepted by a very large number of people especially those with limited or little exposure or training on computers.

Yet another object of the present invention is to provide a display device that would be priced within the range of most consumers and others that would like to use electronic information storage and display system.

Yet another object of the present invention is to enable individuals, students and others, to decrease the weight and volume of books presently being carried and handled by these persons.

Another object of the present invention is to provide multimedia information storage and display system that will replace presently existing paper text book and/or other printed material

Another object of the present invention is to alleviate the dependence on paper as the physical media for every copy of a publication.

A further object of the present invention is to reduce inventory, distribution and printing costs for publishers.

Yet another object of the present invention is to provide a system for distributing text book and/or other printed material to consumers at a cost less than that for paper printed materials.

Still another object of the present invention is to provide an environmentally friendly paperless means for collecting, storing, distributing and displaying conventionally printed materials.

Another object of the present invention is to provide a sales and/or distribution system for printed material in electronic format as simple, secure and affordable as exists for paper based printed materials.

Another object of the present invention is to provide easy access to book publications and the like at a cost less than the printed equivalent.

Another object of the present invention is ability for printed material in electronic format from all Publishers to be distributed globally via wired, wire-less, optical and satellite communications systems

Other objects and advantages will be apparent from the following description of the invention, and the novel features of the invention will be particularly pointed out in the claims.

### BRIEF DESCRIPTION OF THE DRAWINGS

The invention is illustrated in the accompanying drawings:

FIG. 0: Isometric View showing the main elements of the Personal Electronic Text Library System [PETLS] B-Book.

FIG. 1: Personal Electronic Library System [PETLS] layout. This layout presents all the different components of the PETLS.

FIG. 2: Plan/Top End/Bottom End/Left Side/Right Side Views showing the elements of the PETS B-Book.

FIG. 3: B-Book Right Handed User Configuration/Left Handed User Configuration of the notebook style layout, showing main components.

FIG. 4: B-Book Right Handed User Configuration/Left Handed User Configuration of the laptop style layout, showing main components.

FIG. 5: B-Book Right Handed User Configuration/Left Handed User Configuration of the horizontal hinge and vertical hinge style layout, showing main components.

FIG. 6: Intentionally left blank.

FIG. 7: Intentionally left blank.

FIG. 8: Intentionally left blank.

FIG. 9: Intentionally left blank.

FIG. 10: Intentionally left blank.

FIG. 11: B-Book Basic Electronic Layout

### DETAILED DESCRIPTION

The Personal Electronic Text Library System [PETLS] Overview:

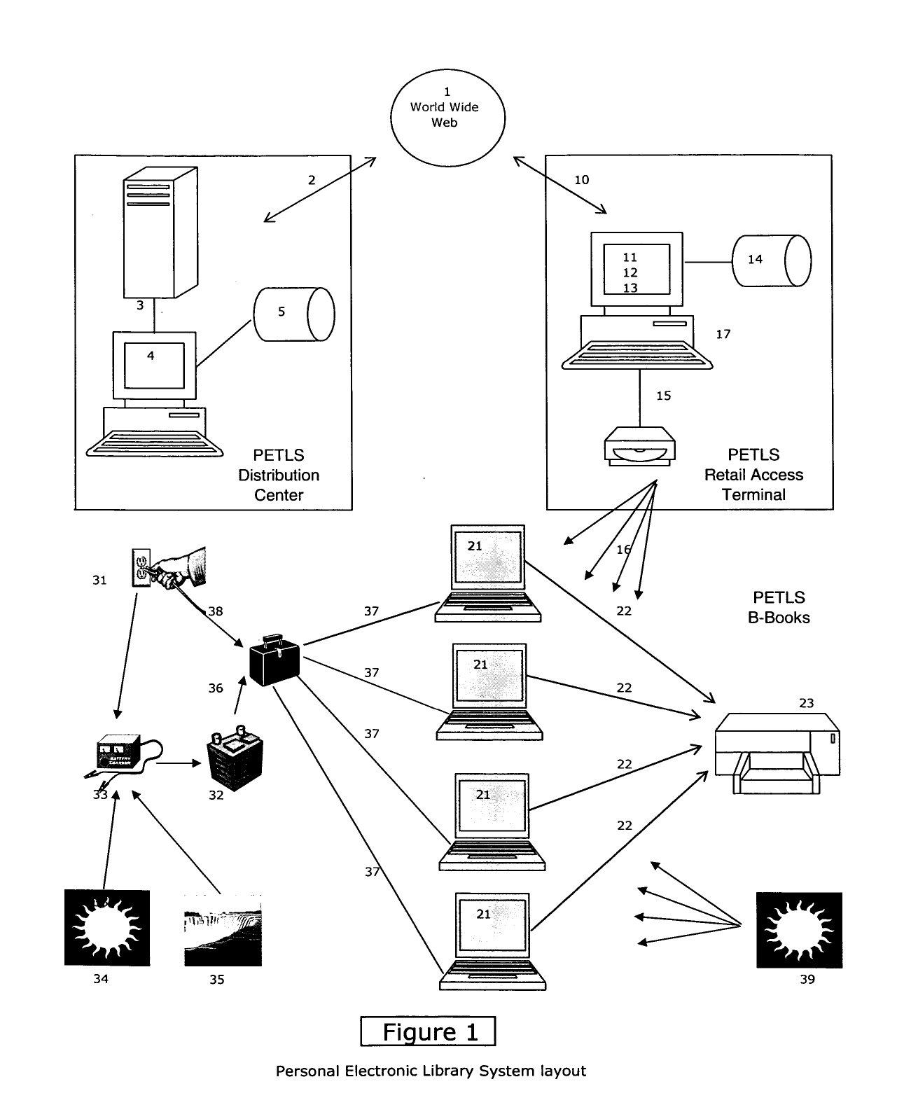

The Personal Electronic Text Library System [PETLS] shown in FIG. 1 is comprised of the components: the PETLS Distribution Center, multiple PETLS Retail Access Terminals, multiple PETLS Electronic Storage Media and multiple B-Book dedicated display devices. Together these components provide a means for the sale and distribution of text books and/or other printed material in electronic format from all publishers of this type of material to all individuals interested in accessing this type of material. The connection to and the interconnections within PETLS can be via wired, wire-less, optical and/or satellite communications networks or the like utilizing the Internet protocol or the like and thus can be accessed globally where such communication networks currently exist or can reach in the future.

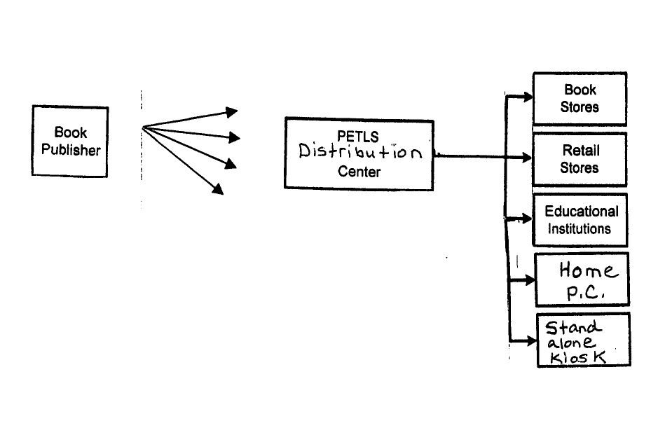

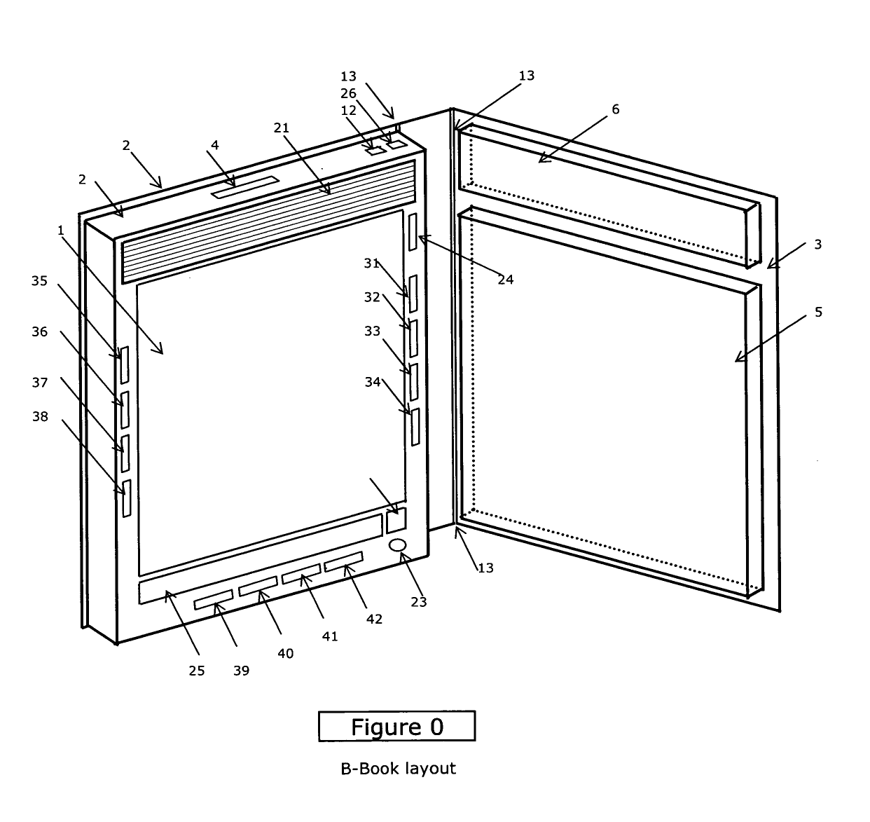

One or more levels of protection against unauthorized duplication are utilized as this type of material is entered into PETLS, stored within PETLS and transferred between the components of PETLS until it reaches, via the PETLS Electronic Storage Media, the B-Book device (see FIG. 0) which is the only component of PETLS capable of accessing and displaying the protected material. The protected material stored on the PETLS Electronic Storage Media can be purchased and/or shared and/or lent and/or traded and/or donated by and/or between any and/or all individuals and/or users of dedicated B-Book display devices displaying protected material in a manner similar to that experienced with paper printed materials.

The PETLS Distribution Center component is the collection and storage point for all text book and/or printed material entered into PETLS. Material from publishers is protected against unauthorized access and/or duplication using a protection scheme (or schemes) that employ PETLS assigned Publisher Identification and Protection Codes. Once material is within the PETLS Distribution Center the protection scheme used during material transfer is converted to a PETLS internal protection scheme and the material is securely stored so as to prevent unauthorized access.

When a verified sales transaction is received from a Retail Access Terminal a copy of the requested material is sent to the Retail Access Terminal using a secured transfer sequence based on PETLS assigned Retail Access Terminal Identification and Protection Codes.

The Retail Access Terminals are the points of access to text book and/or printed material stored within PETLS. Individual consumers can examine the Master List of all available material using familiar search approaches as the Master List will contain the usual Author, Title, ISBN, etc. descriptions. Once a selection is made a sales transaction sequence is executed and a copy of the requested material is transferred from the PETLS Distribution Center to the Retail Access Terminal using a secured transfer sequence and the material is then written onto a PETLS Electronic Storage Media and given to the consumer.

The Retail Access Terminals can be located at conventional bookstores, libraries, educational institutions and stand-alone kiosks at convenience stores, in stores, in malls, in airports and other such locations readily accessible to consumers, including in-home situations.

The PETLS Electronic Storage Media component is the portable physical media on which is stored, in a form protected against unauthorized duplication, text book and/or other printed material. This media can be one of a flash card, a media card, a secured media card, a memory stick, a PCMCIA memory card, an optical storage disc, or the like.

Each PETLS Electronic Storage Media contains a secured access portion for the storage of text book and/or other printed material protected against unauthorized duplication. Proprietary hardware and/or software resident on the media are used to provide a further level of protection against unauthorized duplication. Only the Retail Access Terminal can write material to the secured access portion.

In addition, there is an unsecured access portion which is used to stored unprotected material such as user created notes, reviews of material and the like as the protected material is displayed. Both the Retail Access Terminal and the B-Book can write material to the unsecured portion.

The PETLS B-Book component replaces a standard handheld book or a plurality of text books and/or other printed material, with an electronic equivalent. The B-Book is sized and configured to be book size and to open like a text book, or book, or notebook, or pocket sized notebook for use. One side holds a display screen with black print on a white background, or colour as per user choice and on the other side a note pad.

The B-Book will have multiple functions for controlling the display of material on the display screen such as bookmarks, text string search, zoom in/out, page advance and previous page re-display, specific page selection, split screen display mode and the like under user control via commands entered from a detachable keyboard, or via icon activation on a built-in touch-screen.

User created notes, reviews, and the like can be stored in the unsecured access portion of the PETLS Electronic Storage Media and optionally sent via a non-contact means such as wire-less, optical or the like to a device capable of receiving said User created notes, reviews and the like.

Another application of PETLS is to distribute material to a tightly restricted group of individuals such as a single company, or a group of companies, governments, and the like requiring closed restricted access to sensitive material. All of the components of PETLS would be modified to meet the requirements of such applications as required.

The PETLS Distribution Center with Connection to the World Wide Web Comprises:

a permanent connection (FIG. 1 Item 2) to the World Wide Web (FIG. 1 Item 1); and

the PETLS Distribution Center (FIG. 1 Item 3) with processing means to receive text book and/or printed material in electronic format from external publishers via Internet connections (FIG. 1 Item 2) and to transmit said material to the PETLS Retail Access Terminal (FIG. 1 Item 11) via the World Wide Web; and

a processing means (FIG. 1 Item 3) for handling PETLS Retail Access Terminal requests, managing registration and user security code processes and downloading page composition formatted publications (electronic text books, electronic study books, magazines, journals and the like); and

a permanent storage means (FIG. 1 Item 5) for storing the registration and user security codes, the page composition formatted information, such means comprising a plurality of database storage devices; and

a housing including a display screen (FIG. 1 Item 4) for displaying information and icons on the display screen, the housing having a plurality of function keys corresponding to functions provided by the PETLS Distribution Center in generating the copy of the selected text book and/or printed material in electronic format, and transmitting said copy of said material to the PETLS Retail Access Terminals; some of the functions being represented by icons displayed on the display screen, the icons displayed on the display screen varying in accordance to a selected function; and

The PETLS Retail Access Terminals with a Connection to the World Wide Web Comprises:

a permanent connection (FIG. 1 Item 10) to the World Wide Web (FIG. 1 Item 1) and the computing means (FIG. 1 Item 11) to transmit requests for text book and/or printed material in electronic format to and receive copies of said material from the PETLS Distribution Center (FIG. 1 Item 3); and

a processing means (FIG. 1 Item 12) for handling user requests, sending the requests to the PETLS Distribution Center (FIG. 1 Item 3) and downloading page composition formatted publications (electronic text books, electronic study books, magazines, journals and the like) from the PETLS Distribution Center; and

a temporary storage means (FIG. 1 Item 14) for temporarily storing the page composition formatted material; and

a processing means (FIG. 1 Item 12) for downloading page composition formatted publications (electronic text books, electronic study books, magazines, journals and the like) temporarily stored in the temporary storage means (FIG. 1 Item 14) onto a removable portable permanent electronic storage media [PETLS Electronic Storage Media] (FIG. 1 Item 15); and

a housing including a display screen (FIG. 1 Item 13) for displaying information and icons on the display screen, the housing having a plurality of function keys corresponding to functions provided by the PETLS Retail Access Terminal in generating the request to the PETLS Distribution Center, some of the functions being represented by icons displayed on the display screen, the icons displayed on the display screen varying in accordance to a selected function; and

a processor (FIG. 1 Item 12) coupled to the temporary memory storage means and the display screen for controlling the retrieval of the received copy of the selected text book and/or printed material, the processor receiving input from the function keys and for controlling the display of the retrieval activity icons on the display screen; and

a set of the function keys (FIG. 1 Item 17) located on the keyboard, each function key of the said set of the function keys being selected by touching the respective key; and

a plurality of devices (FIG. 1 Item 15) that would be able to write data onto the PETLS Electronic Storage Media (FIG. 1 Item 16), data that would represent the text book and/or printed material when inserted into the device; and

a plurality of PETLS Electronic Storage Media (FIG. 1 Item 16) that would be able to store text book and/or printed material in electronic format written by the PETLS Retail Access Terminal (FIG. 1 Item 11) and that would be used by the B-Books (FIG. 1 Item 21) to read said material.

The PETLS B-Book Comprises:

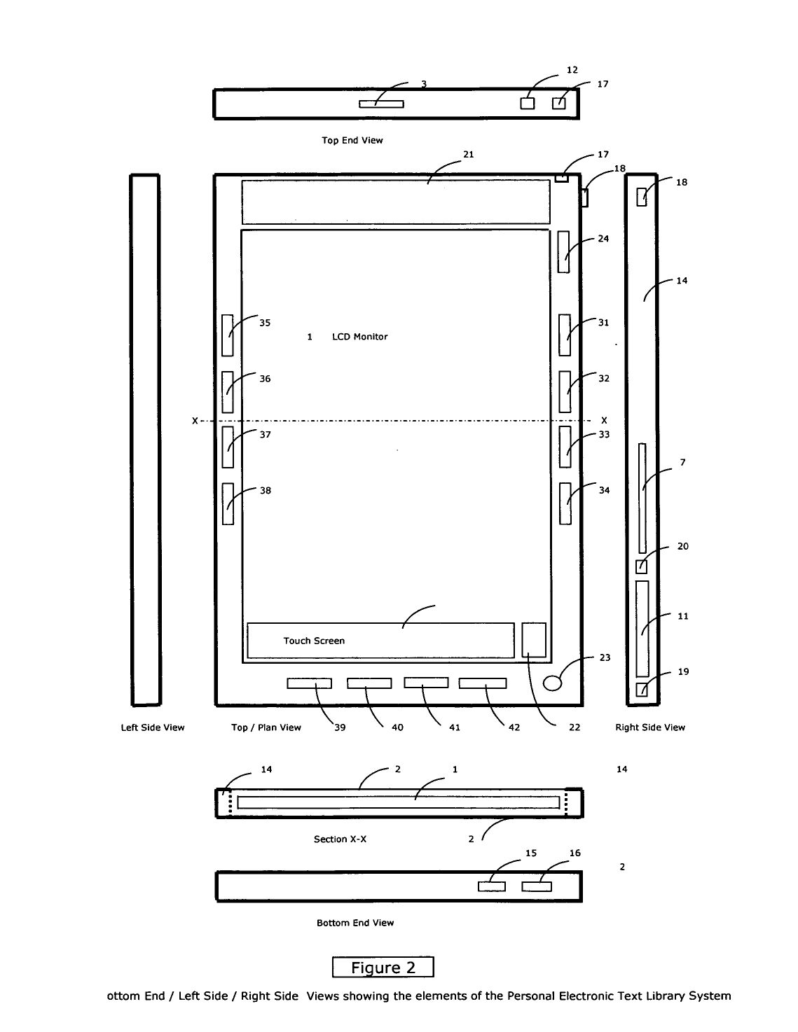

The PETLS B-Book (FIG. 0 or FIG. 1 Item 21 or FIG. 2 or FIG. 3 or FIG. 4 or FIG. 5) is comprised of a display screen mounted on a framed, book-shaped rectangular case, hinged together with a book-shaped, rectangular folder to open and close in the manner of a printed book, an electronic processing means, a communication means, an internal power unit with battery and software means, all configured into a handheld, portable unit. This B-Book further comprises:

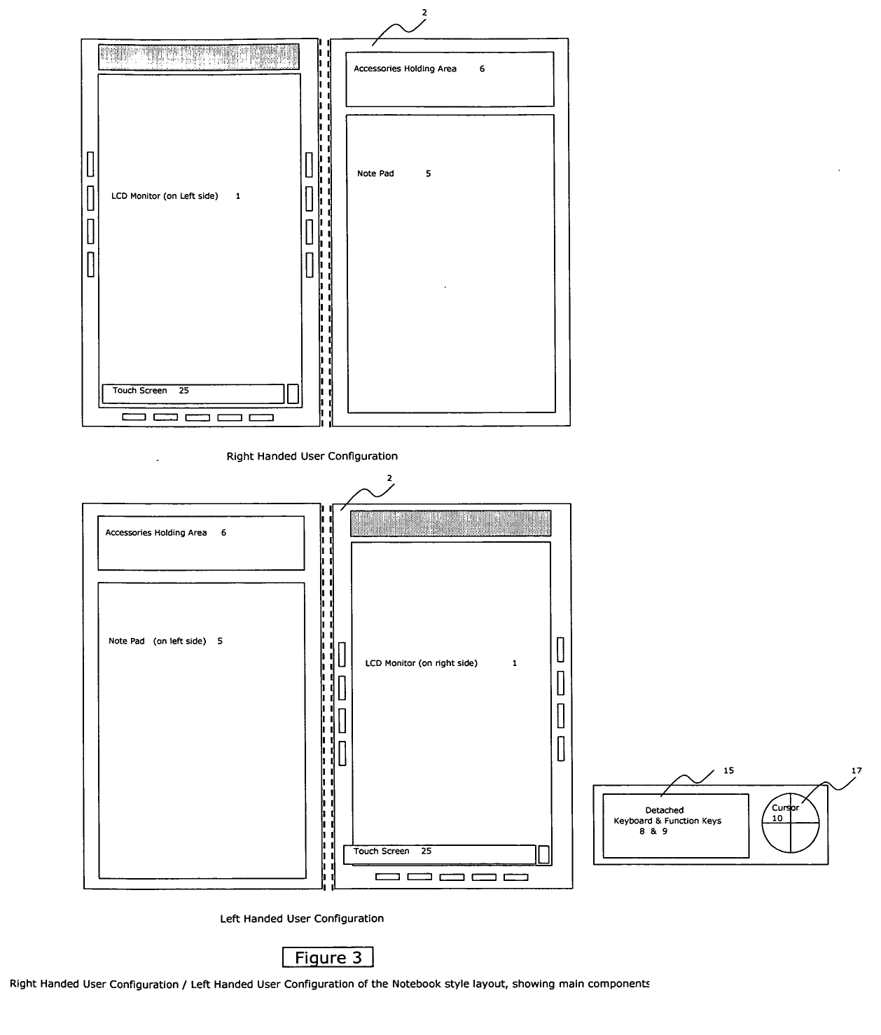

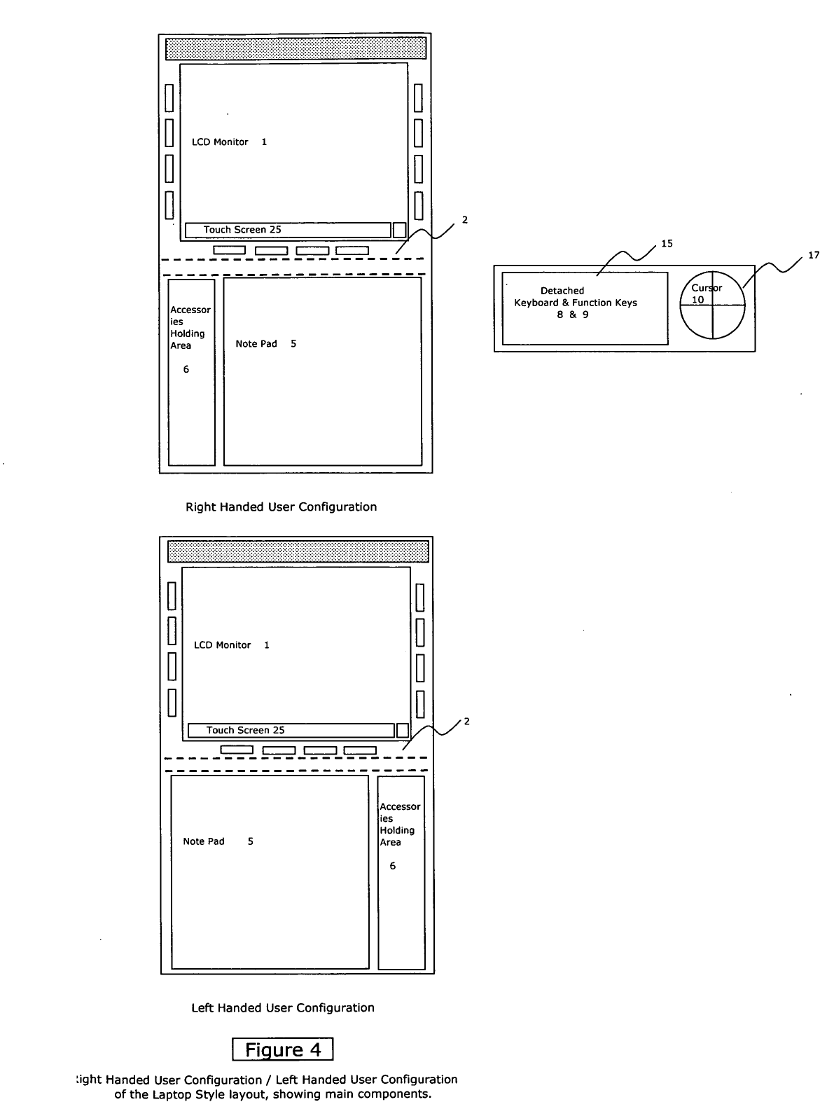

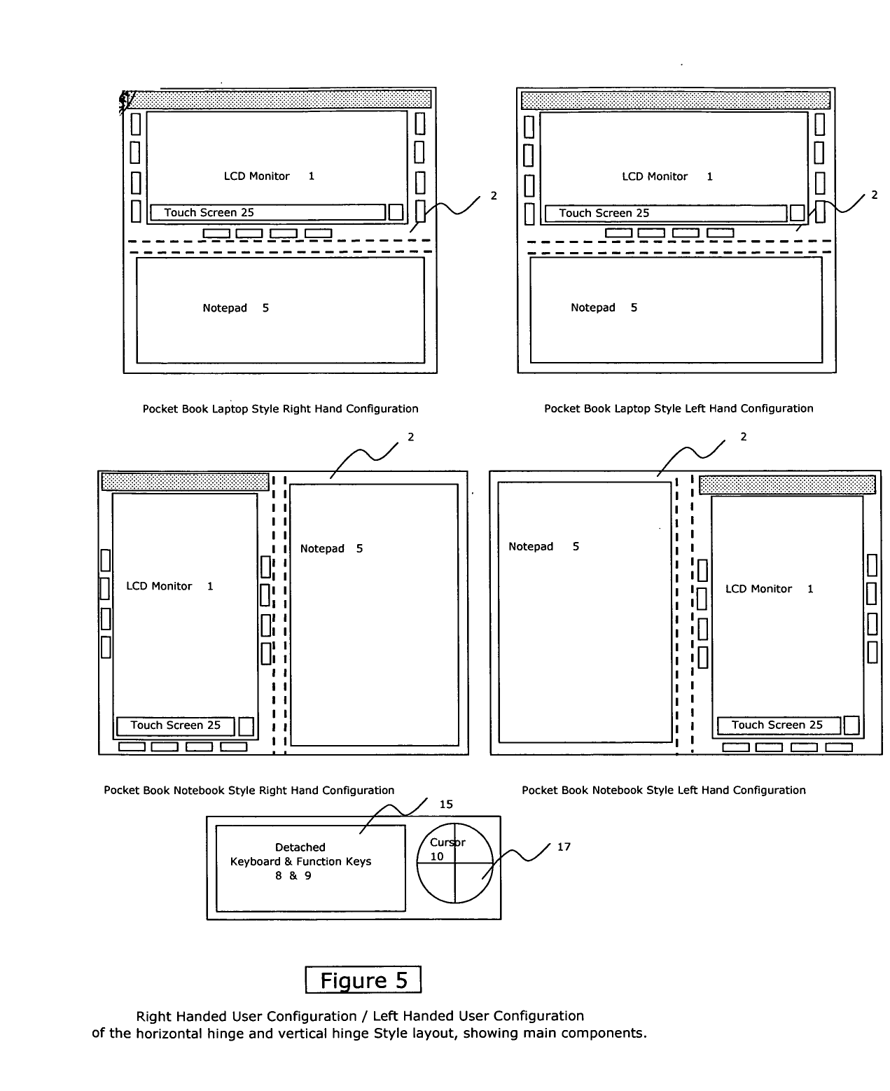

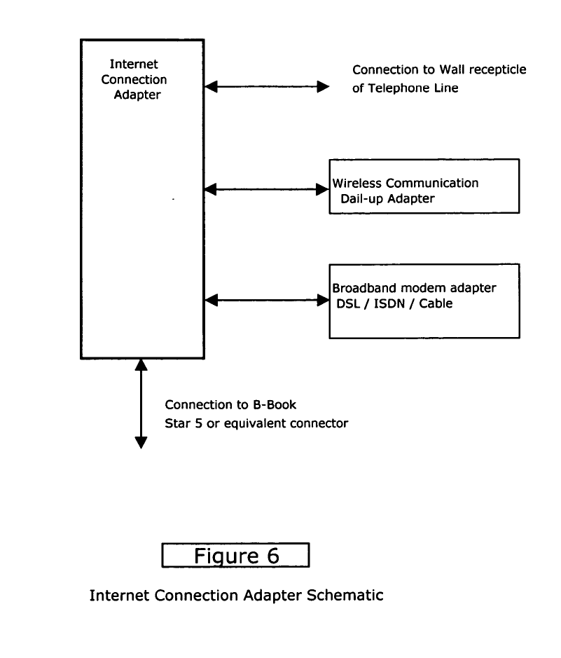

a display screen (FIG. 0 Item 1, FIG. 2 Item 1, FIG. 3 Item 1, FIG. 4 Item 1, and FIG. 5 Item 1) with a touch sensitive screen (FIG. 0 Item 25, FIG. 2 Item 25, FIG. 3 Item 25, FIG. 4 Item 25, and FIG. 5 Item 25) to accept input from the user to communicate with the B-Book; and

a text book-shaped, rectangular, front case (FIG. 0 Item 2, FIG. 2 Item 2 FIG. 3 Item 2, FIG. 4 Item 2, and FIG. 5 Item 2) onto which the display screen (FIG. 0 Item 1, FIG. 2 Item 1, FIG. 3 Item 1, FIG. 4 Item 1, and FIG. 5 Item 1) is mounted and retained; the longitudinal sides of the case are formed in such a way that rechargeable batteries and the like could be mounted into the edges (FIG. 2 Item 14); and

a text book-shaped, rectangular folder (FIG. 0 Item 3, FIG. 3 Item 3, FIG. 4 Item 3, and FIG. 5 Item 3) onto which a notepad (FIG. 0 Item 5, FIG. 3 Item 5, FIG. 4 Item 5, and FIG. 5 Item 5) and accessories holder (FIG. 0 Item 6, FIG. 3 Item 6, and FIG. 4 Item 6) are mounted; and

a hinge means (FIG. 0 Item 13, FIG. 2 Item 13, FIG. 4, Item 13, FIG. 5, Item 13) to mechanically or otherwise connect the one side of the case to the folder, so that when the B-Book is opened, the displays abuts the folder and presents an appearance similar to that of an open printed text book; the hinge means can be disconnected from one side and reconnected on the other side of the casing (FIG. 0 Item 2, FIG. 2 Item 2, FIG. 3 Item 2, FIG. 4 Item 2, and FIG. 5 Item 2) to facilitate right and left handed users; and

an infrared communication means (FIG. 0 Item 4 and FIG. 2 Item 4), or alike, to communicate with other devices such as printers or others so equipped (FIG. 1 Item 23); and

a solar panel means (FIG. 0 Item 21, FIG. 2 Item 21, FIG. 3 Item 21, FIG. 4 Item 21, and FIG. 5 Item 21) using sunlight and ordinary electric light (FIG. 1 Item 39) and converting these sources of light into electric current and applying the said power available into the rechargeable batteries via a charge control system and;

a loudspeaker means (FIG. 0 Item 22, FIG. 2 Item 22) or alike, to emit sound as per user preference; and

a microphone means (FIG. 0 Item 23, FIG. 2 Item 23) or alike, to record sound as per user preference; and

a rechargeable battery charge indicator means (FIG. 0 Item 24, FIG. 2 Item 24) or alike, to indicate the charge status of the rechargeable batteries; and

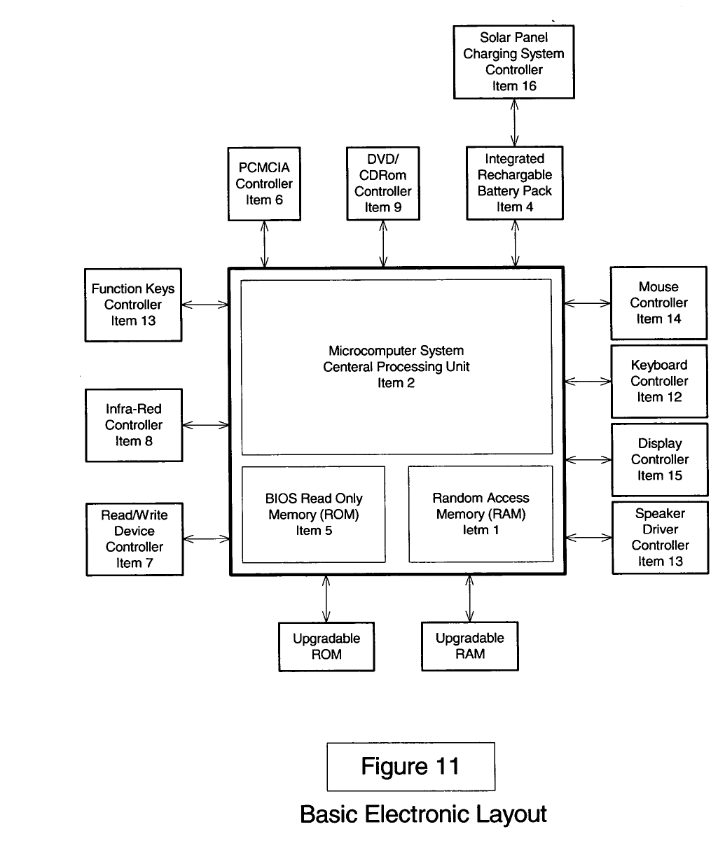

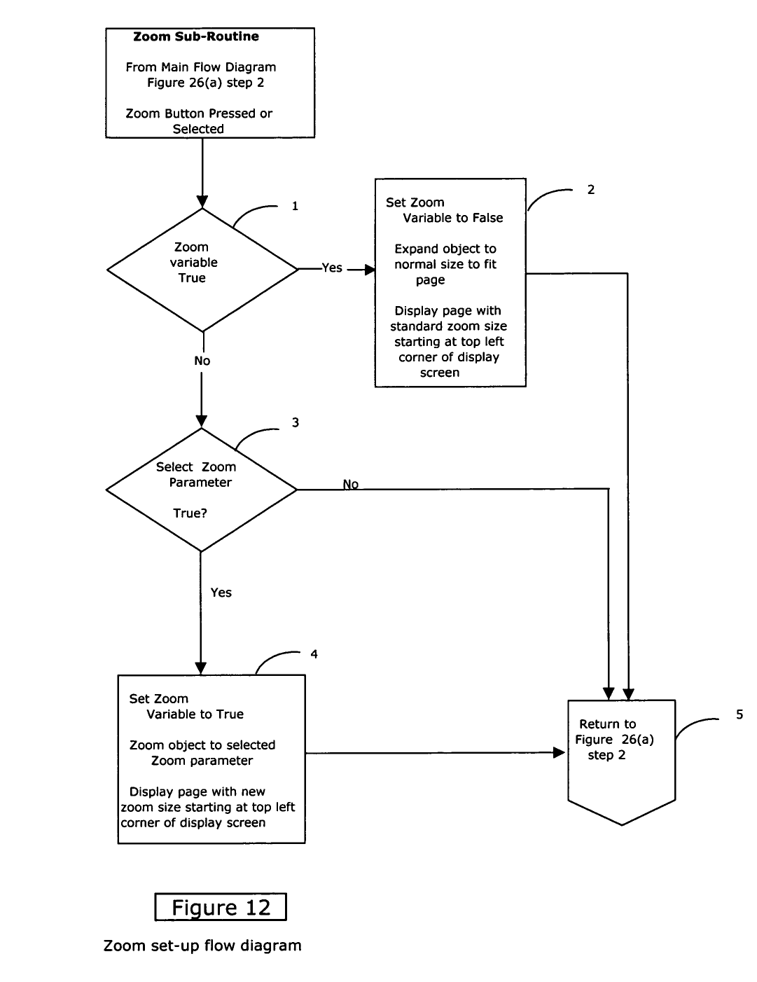

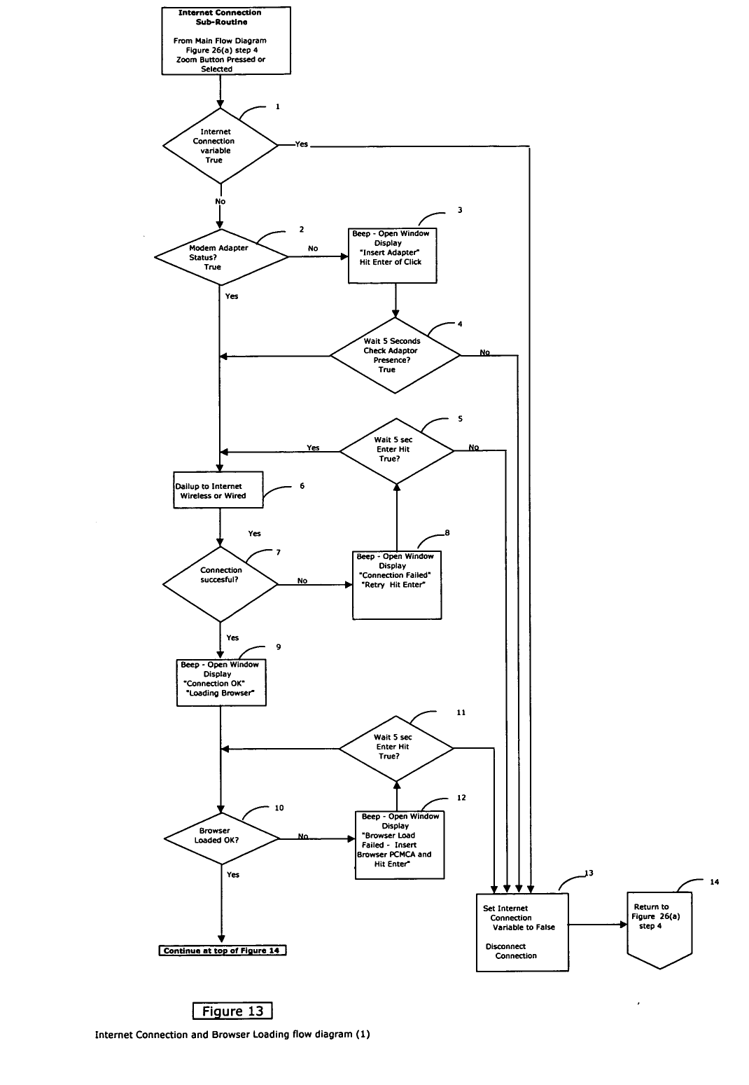

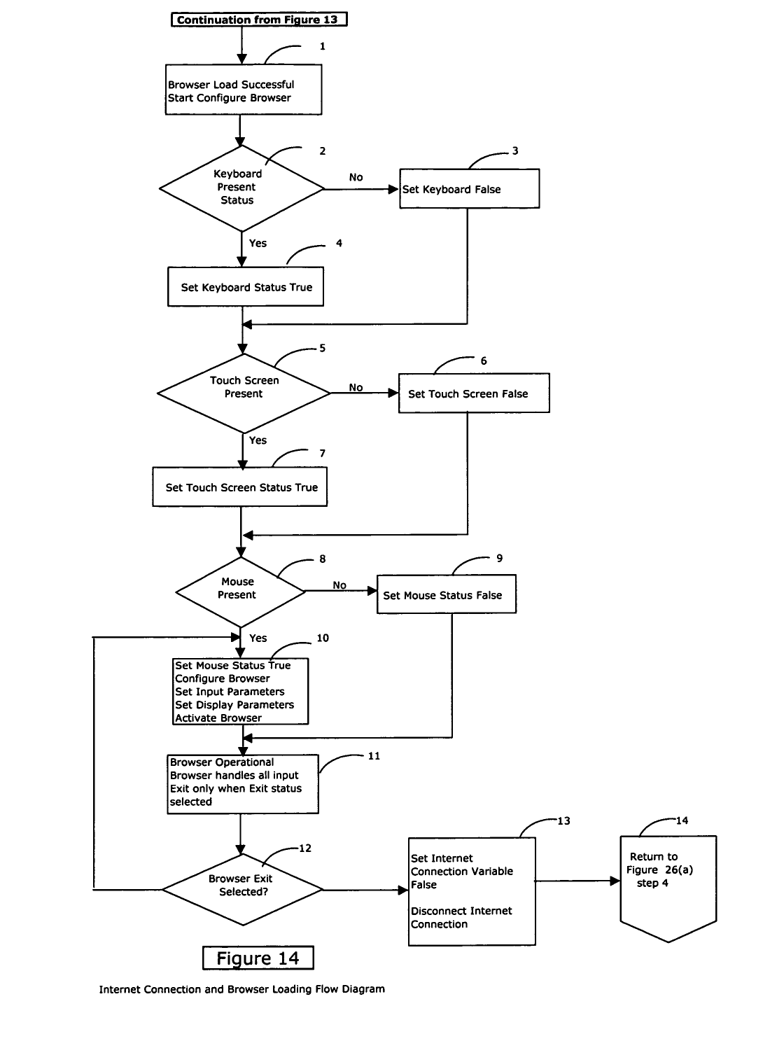

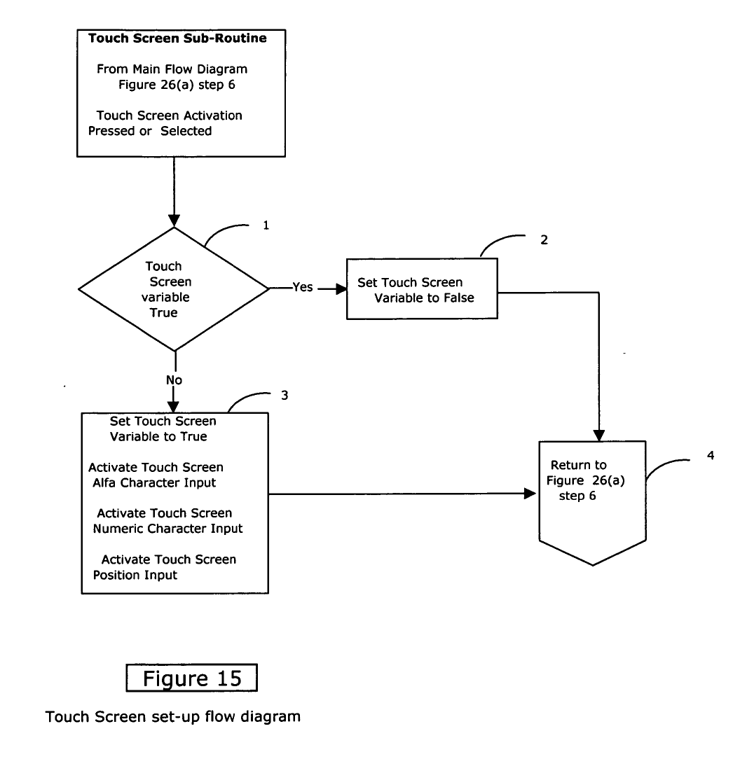

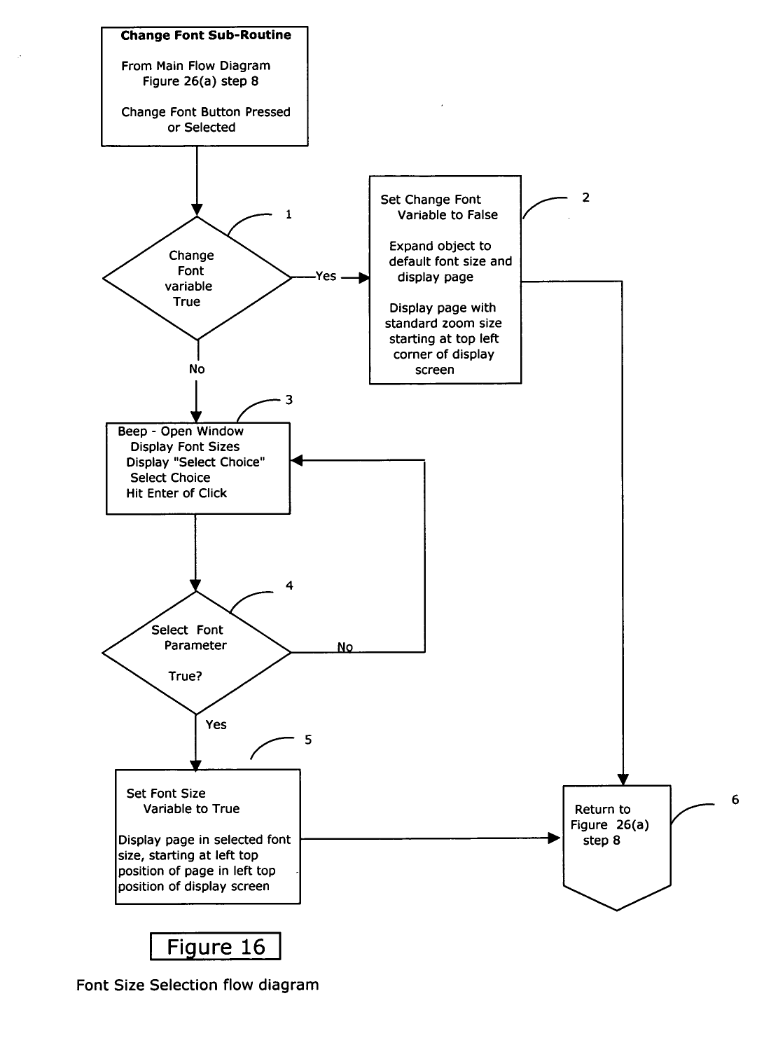

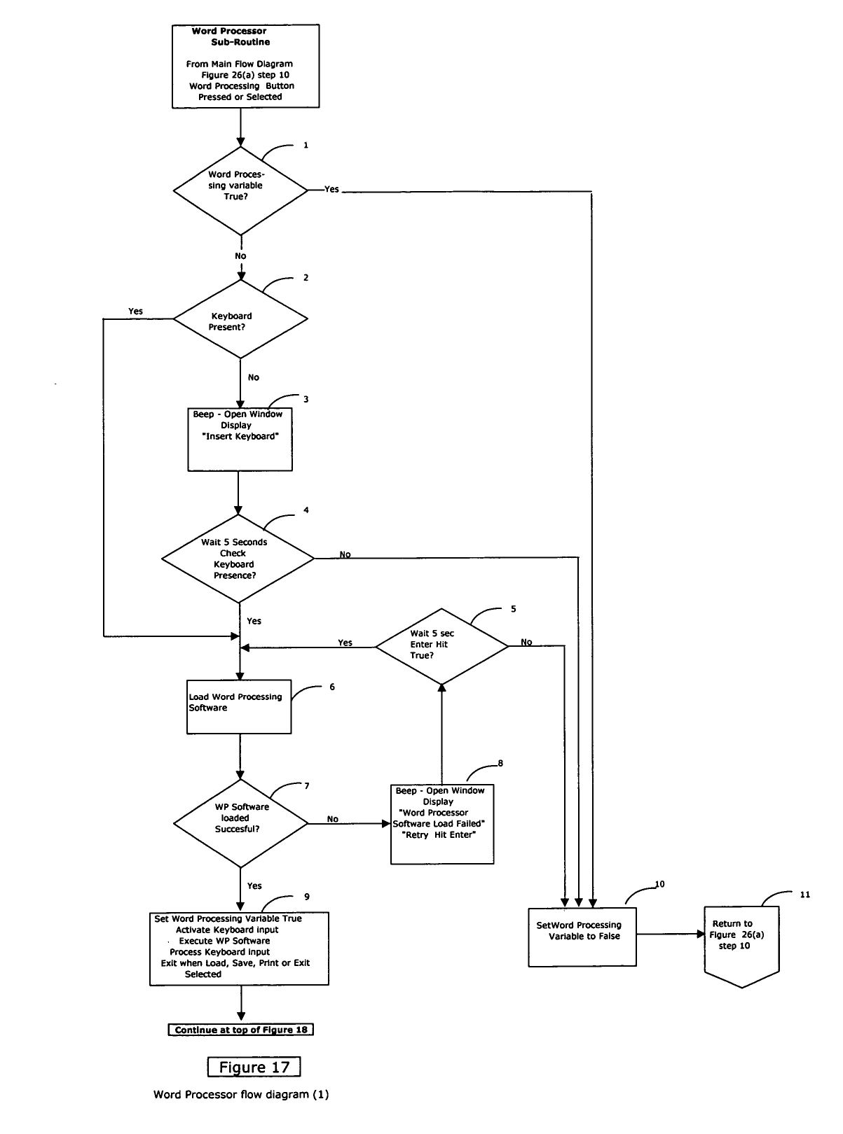

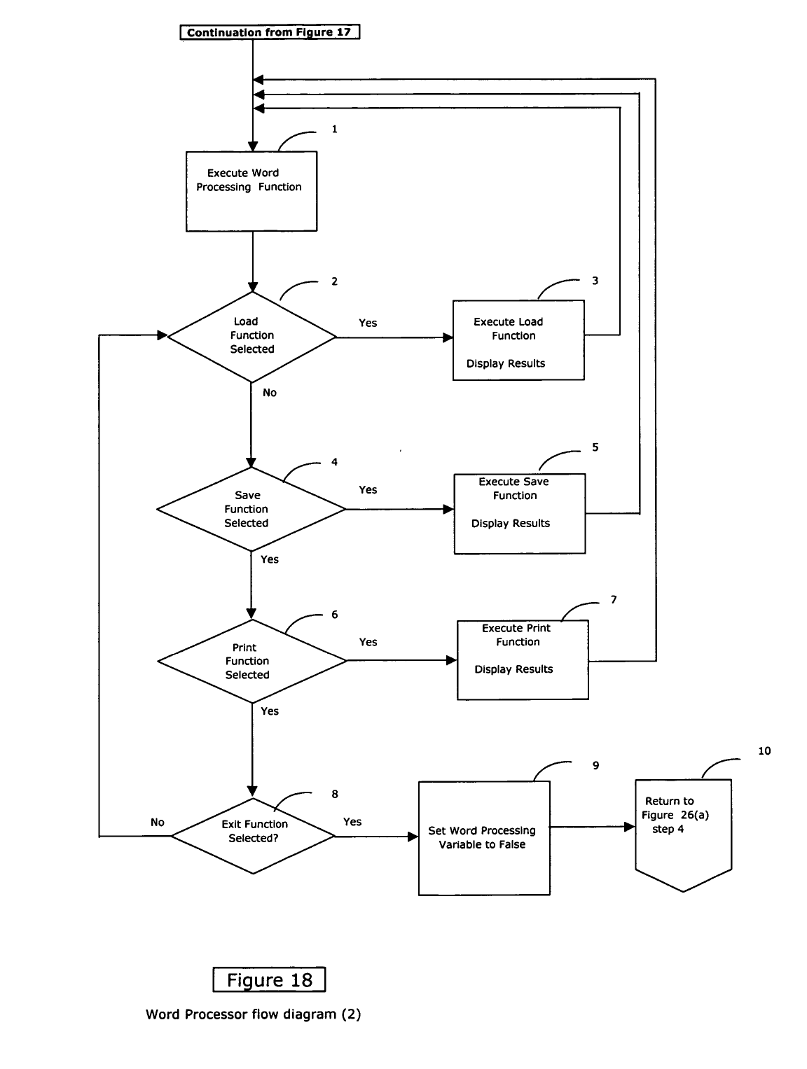

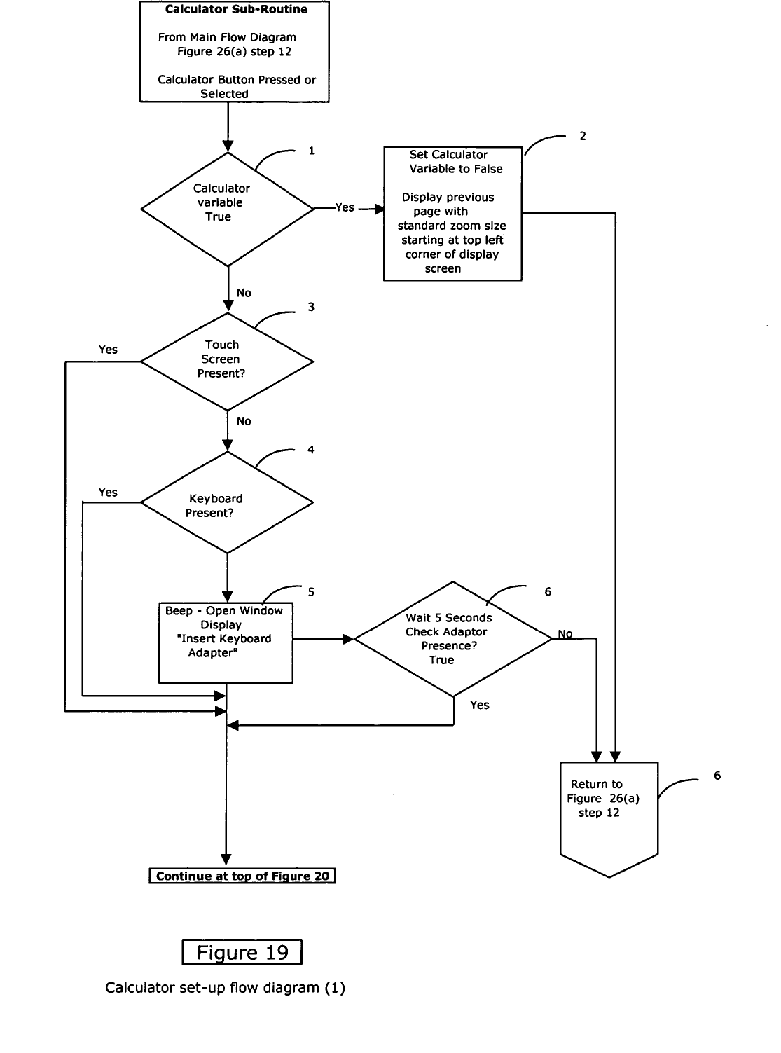

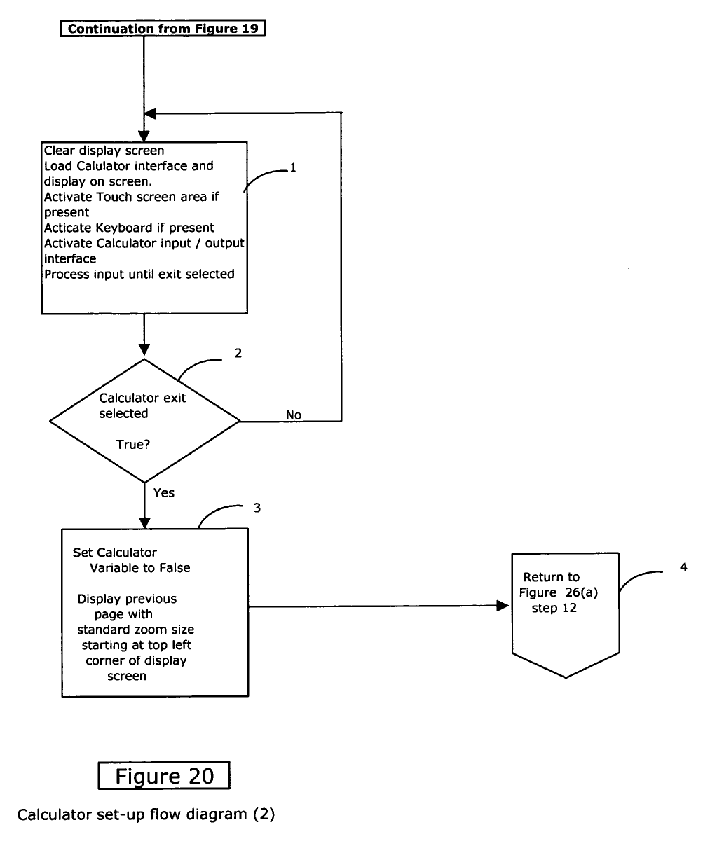

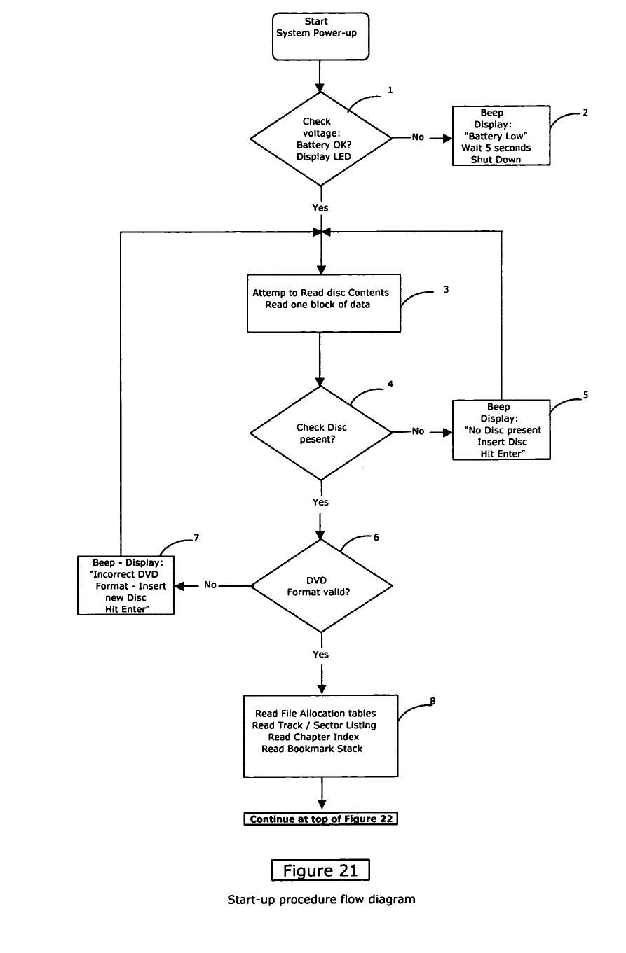

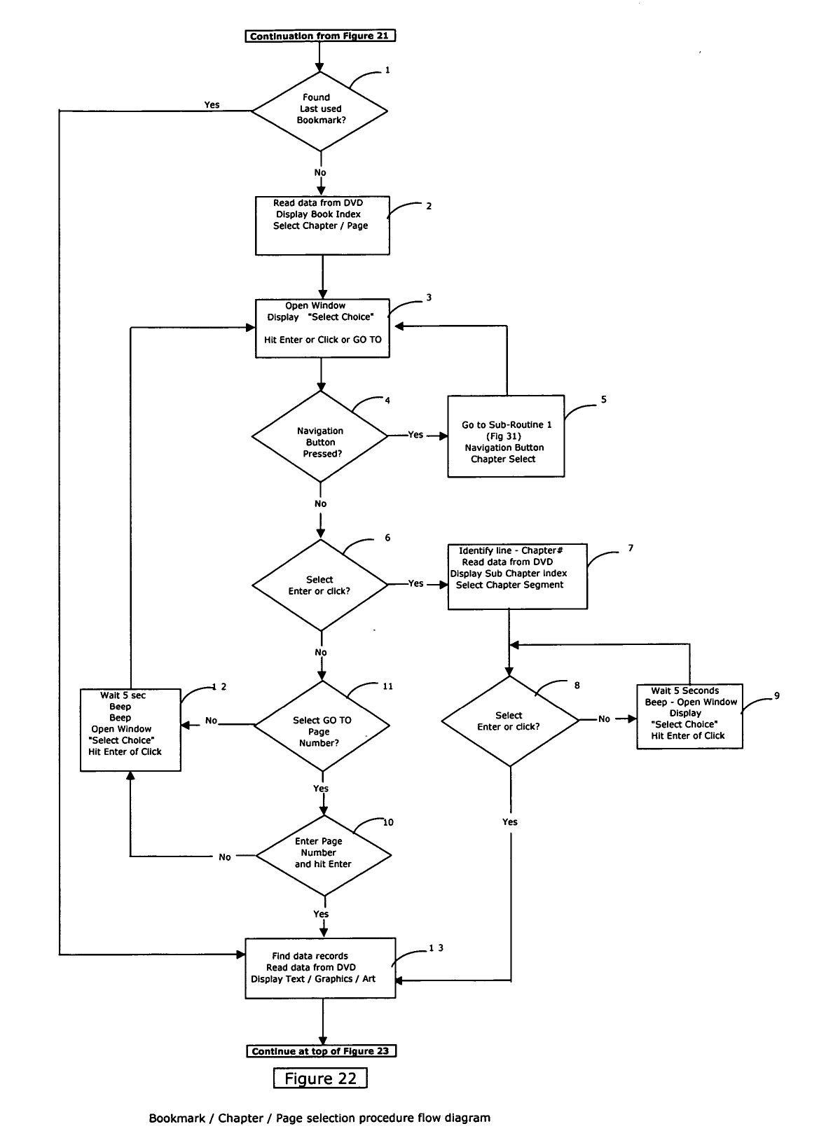

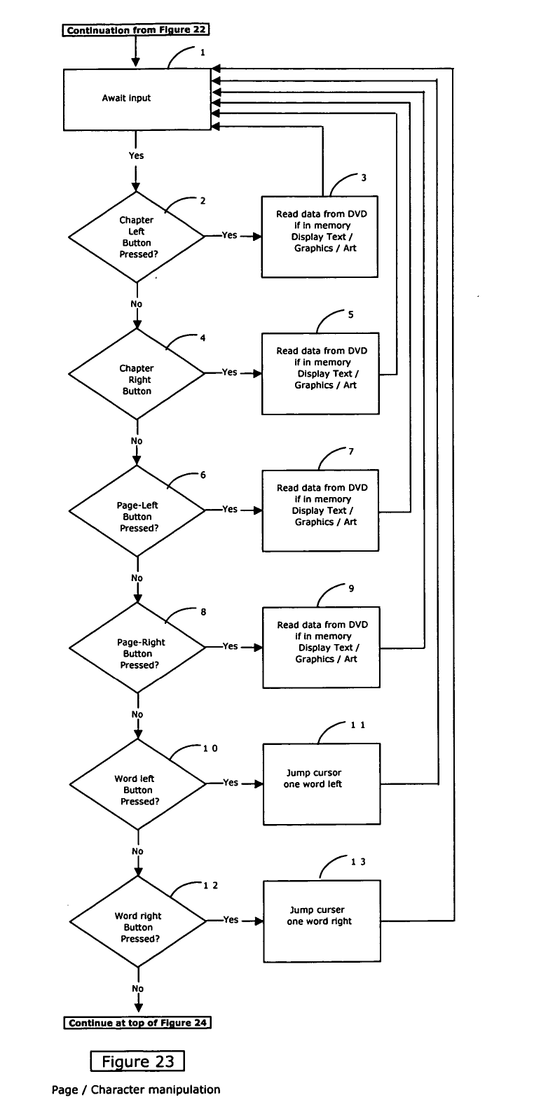

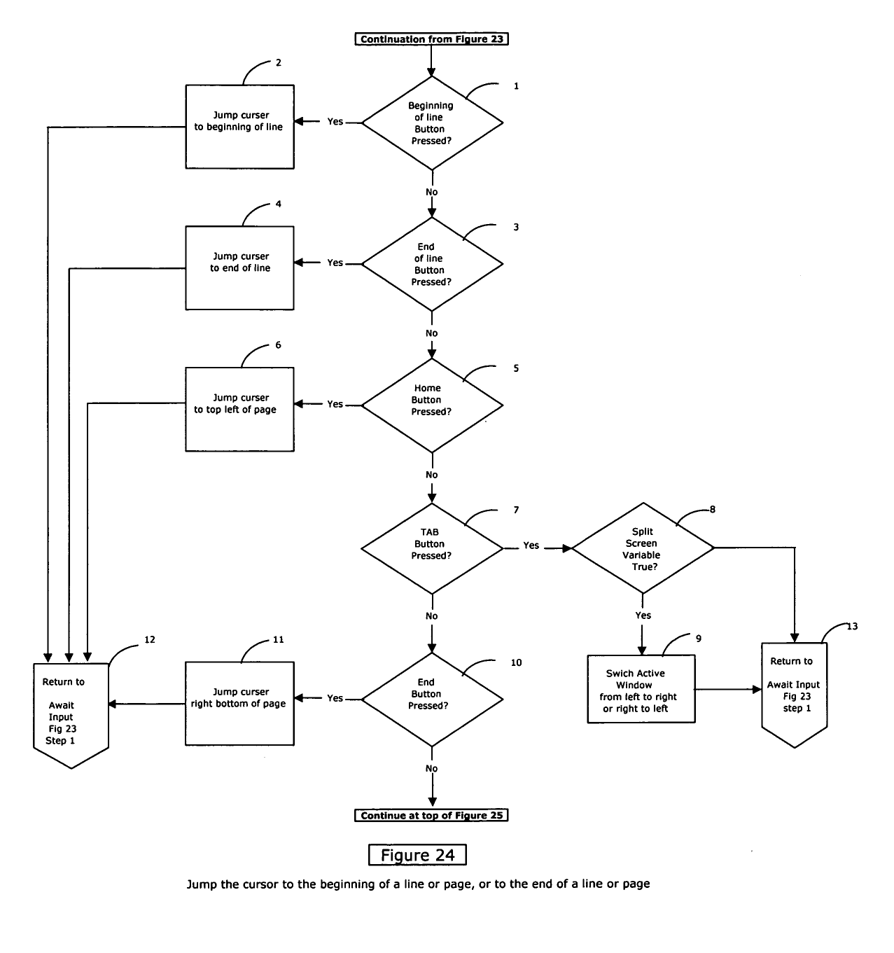

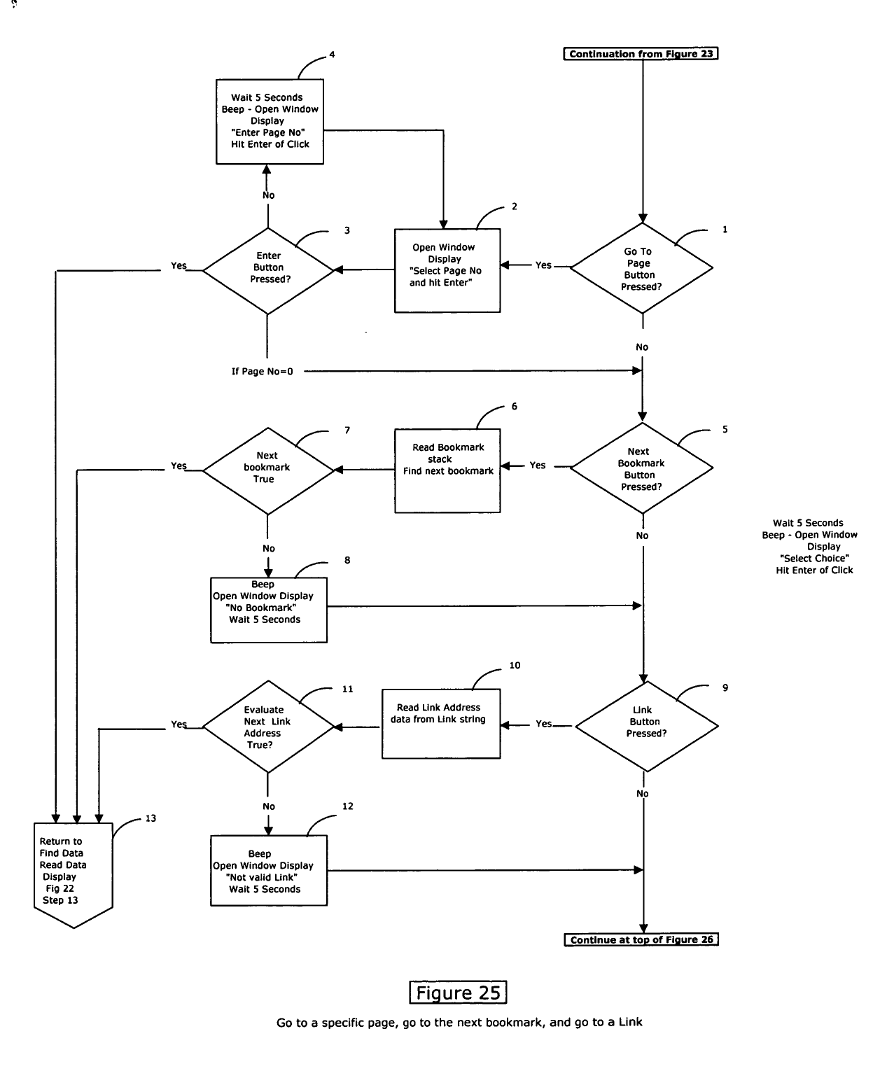

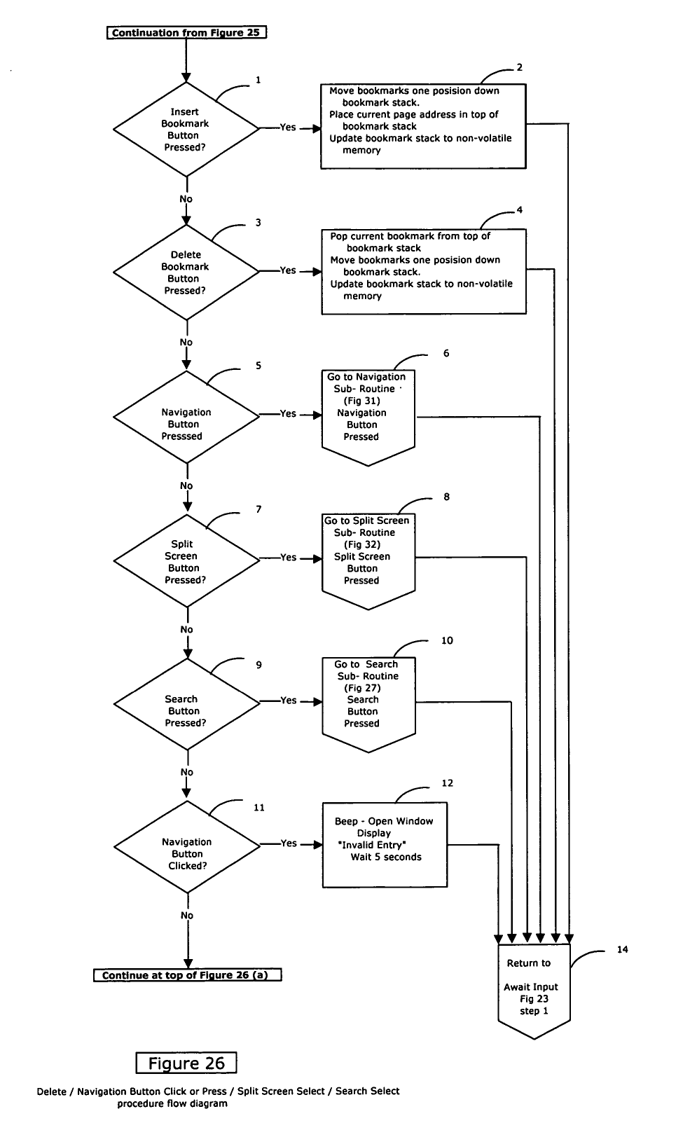

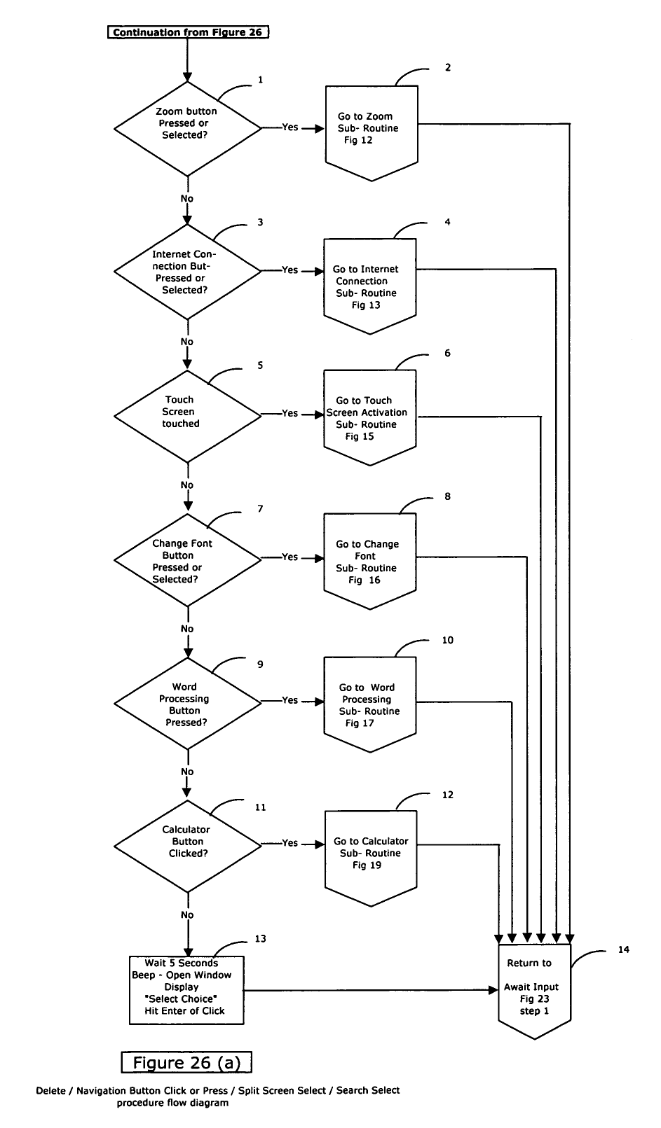

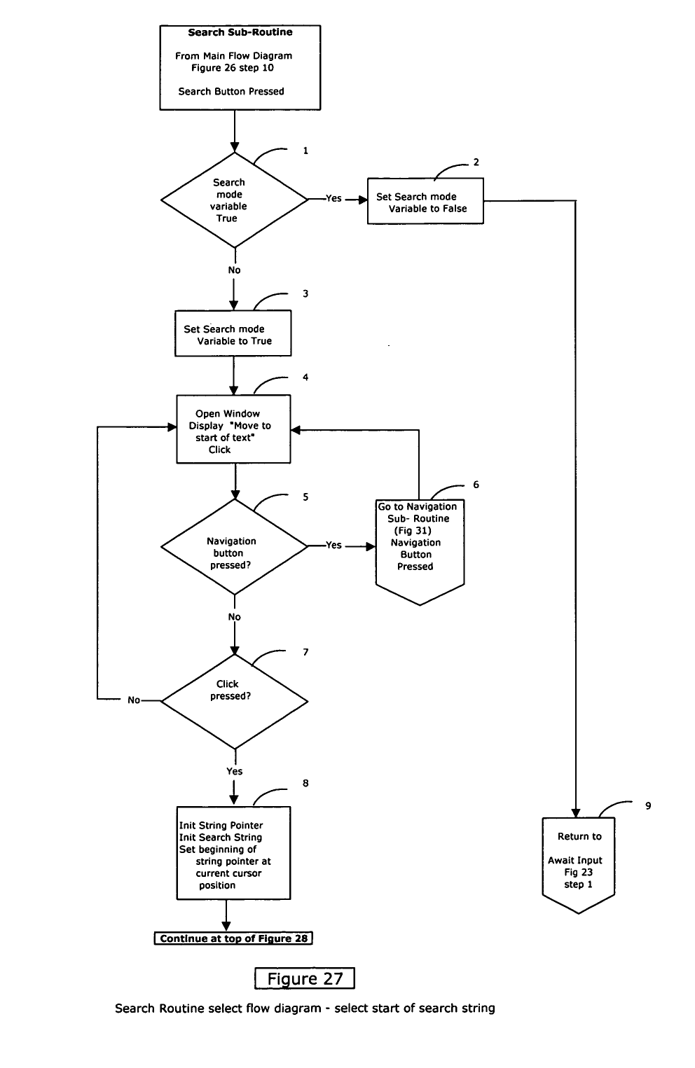

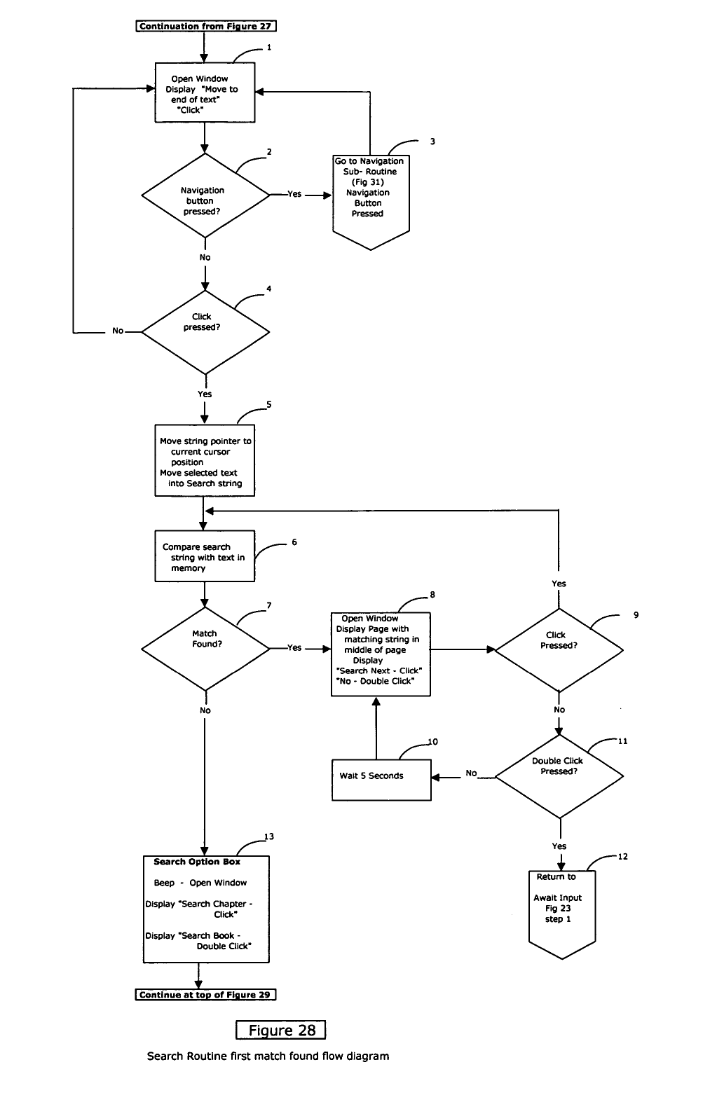

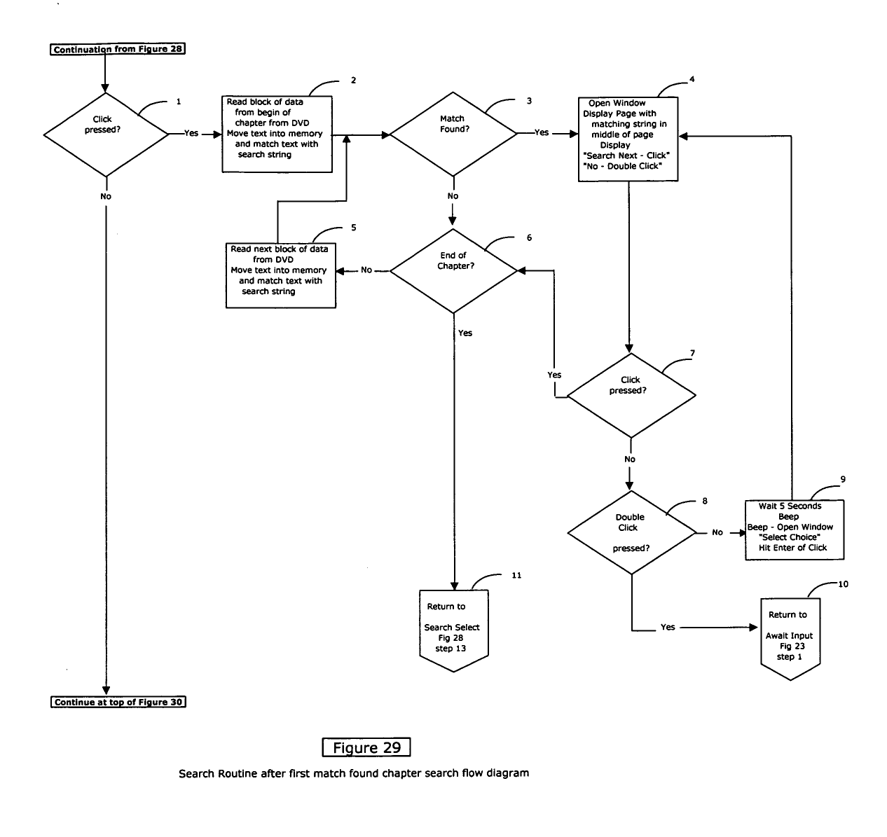

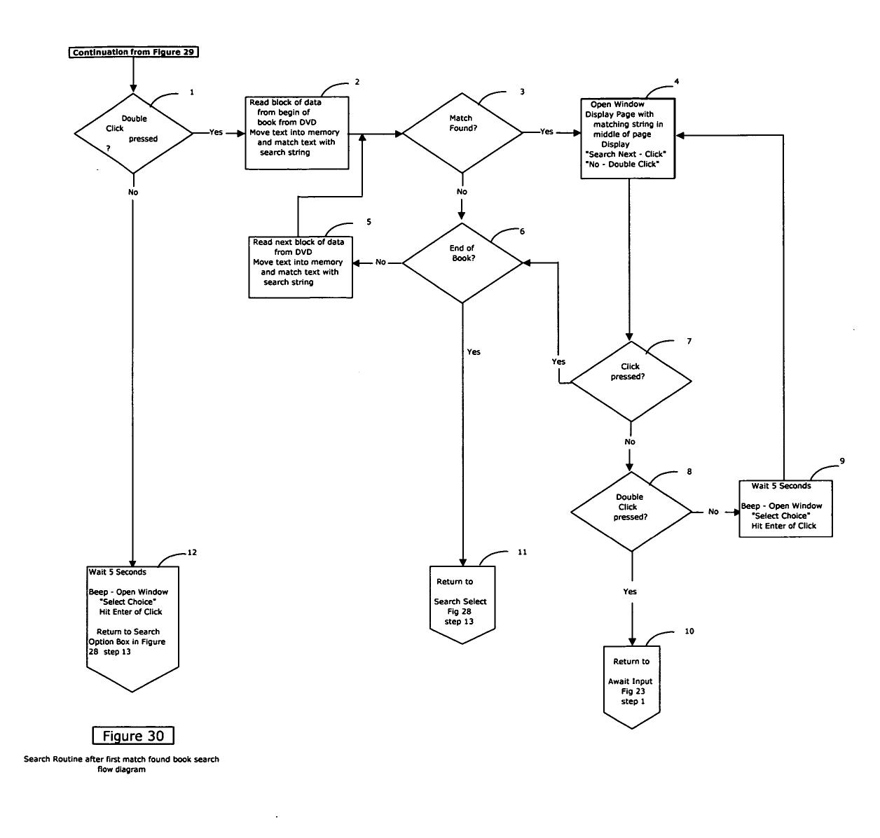

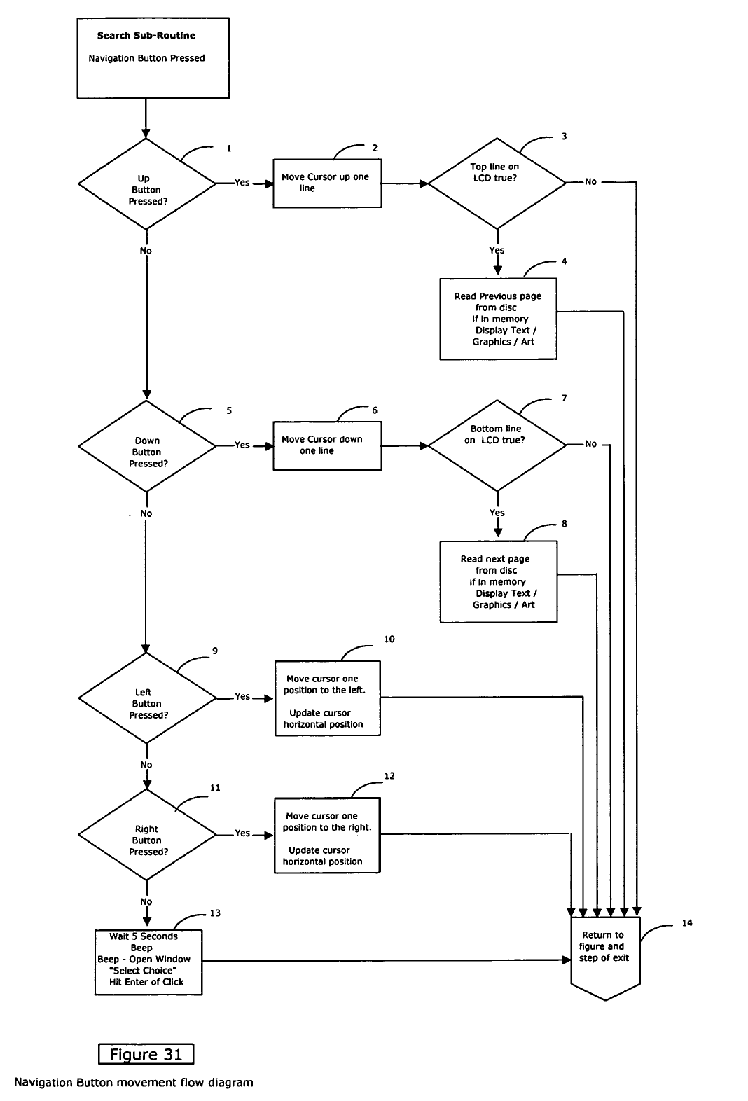

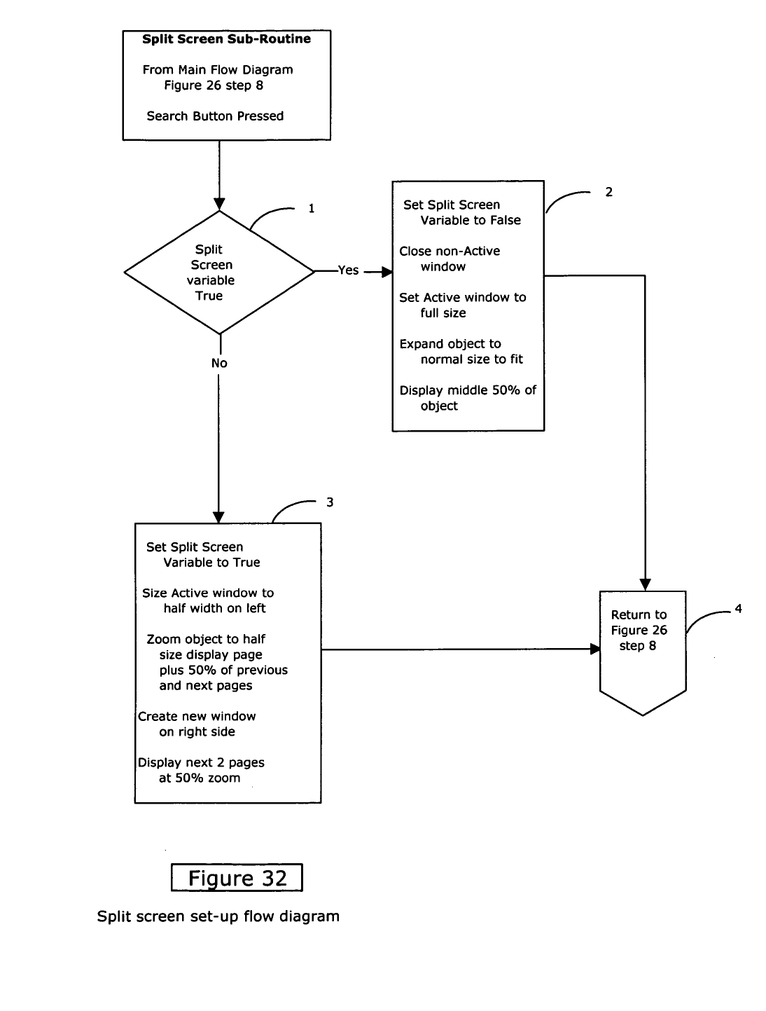

a temporary memory storage means (FIG. 11 Item 1) to temporarily store text of page composed and formatted information (electronic text books, magazines, newspapers, journals, and the like), data, user information, and the like; and

a functional eject button unit (FIG. 2 Item 20) or alike, to eject the PCMCIA memory cards or alike from the B-Book unit; and

a removable portable storage means [PETLS Electronic Storage Media] to store text or printed material of page composed and formatted information (electronic text books, magazines, newspapers, journals, and the like), data, user information, on media such as a PCMCIA card, DVD disc and alike, such means comprising a slot (FIG. 2 Item 11) mounted in the case (FIG. 2 Item 2) for inserting a plurality of cards, DVD discs, or alike; and

a functional eject button unit (FIG. 2 Item 19) or alike, to eject the removable portable storage means [PETLS Electronic Storage Media] from the B-Book unit; and

an internal power unit comprises an internal removable battery or a plurality of internal removable batteries or alike and power and charging circuits (FIG. 11 Item 4) that interface to an AC adapter/charger unit (FIG. 1 Items 36) through a connecting cable (FIG. 1 Item 37); and

a connector means (FIG. 0 Item 12, and FIG. 2 Item 12) to interface an AC adapter/charger device to provide power to recharge the batteries; and

a detachable user input unit (FIG. 3 Item 15, FIG. 4 Item 15 and FIG. 5 Item 15) consisting of a QWERTY keyboard unit or alike (FIG. 3 Item 15 sub-item 8, FIG. 4 Item 15 sub-item 8 and FIG. 5 Item 15 sub-item 8), and function keys or alike (FIG. 3 Item 15 sub-item 9, FIG. 4 Item 15 sub-item 9 and FIG. 5 Item 15 sub-item 9) to accept input from the user to communicate with the B-Book; and a navigation unit (FIG. 3 Item 15 sub-item 10, FIG. 4 Item 15 sub-item 10 and FIG. 5 Item 15 sub-item 10) cum click/double click unit or alike, to accept directional input from the user to communicate with the B-Book; and

a detachable navigation unit, cum click/double click unit or alike, commonly called a mouse, to accept directional input from the user to communicate with the B-Book; and

a connector means (FIG. 2 Item 16) to interface a detachable user input unit (FIG. 3 Item 15, FIG. 4 Item 15, FIG. 5 Item 15) or a mouse to accept input from the user; and

a series of function keys (FIG. 0 Items 31, 32, 33, 34, 35, 36, 37, 38, 39, 40, 41, 42) mounted in the case (FIG. 0 Item 2, FIG. 2 Item 2, FIG. 3 Item 2, FIG. 4 Item 2, and FIG. 5 Item 2) to allow the user to page forward/backward, move a line up/down, move a word right/left, move a character right/left, move a chapter forward/backward, go to a specified page, insert a bookmark, delete a bookmark, turn the split screen function on/off, search for text, zoom in/out, print, execute the enter function, or alike; and

a functional on/off button unit (FIG. 0 Item 17 and FIG. 2 Item 17) or alike, to accept input from the user to switch the B-Book unit on or off; and

a functional display screen sleep on/off button unit (FIG. 2 Item 18) or alike, to accept input from the user to switch the B-Book display screen on or off; and

an electronic processing means (FIG. 11) to control and monitor the operations of the B-Book in accordance with user requests and under software control, said means comprising a microcomputer system (FIG. 11 Item 2); with random access memory (FIG. 11 Item 1); a display screen controller (FIG. 11 Item 3); a power unit (FIG. 11 Item 4); a removable portable storage media controller (FIG. 11 Item 9); an updateable memory storage media controller (FIG. 11 Item 6); an infrared or alike wireless computing controller (FIG. 11 Item 8); a read/write device controller (FIG. 11 Item 7); a keyboard controller (FIG. 11 Item 12); a function keys controller (FIG. 11 Item 13); a mouse controller (FIG. 11 Item 14); and a speaker driver controller (FIG. 11 item 15) and

an updateable software means comprises a proprietary operating system embedded in a solid-state device, the BIOS read only memory (FIG. 11 Item 5), said software means controlling all the functions of the B-Book.

The B-Book Software Comprises:

the BIOS (Binary Instruction Operating System), the Operating System platform (Linux, Windows CE, QNX or the like) and the Application Software platform (Java 2, C++, Visual Basic or the like); and

embedded software for controlling the various hardware features of the B-Book, the display, the touch screen, the navigation tools, the speaker output, the microphone input, the detachable keyboard, the portable storage media reader means, the infrared or alike communication means, and the like; and

embedded software for accessing the protected text book and/or printed material from the secured access portion of the PETLS Electronic Storage Media and temporarily un-locking the protection means while said material is displayed on the display screen of the B-Book, a single page at a time for normal display screen operation and two pages at a time for split display screen operation; and

applications software for managing user created notes, reviews, and the like and the writing of same to the unsecured access portion of the PETLS Electronic Storage Media and optionally for transmitting same via infrared or alike means to devices equipped to receive such transmissions.

The Power Supply System:

The Power Supply System consists of a Power Adapter (FIG. 1 Item 36) that could either plug into a wall electrical outlet (FIG. 1 Item 31) via a connector cable (FIG. 1 Item 38), or into a battery adaptor system (FIG. 1 Item 32) via an connector cable (FIG. 1 Item 38), a battery charging system (FIG. 1 Item 33) that would recharge the battery adaptor system from a plurality of energy sources including a wall electrical outlet (FIG. 1 Item 31), a solar energy system (FIG. 1 Item 34), or a hydro energy system (FIG. 1 Item 35), or the like. The Power Supply System comprises:

a Power Adapter (FIG. 1 Item 36) that would be multi-voltage input compatible transformer enabling the user to draw power of any source of electricity below 250 Volts. This unit will bring power to the PETLS B-Book either from a wall electrical outlet (direct power connection) or a battery pack with the standard connector cable (FIG. 1 Item 38); and

a Battery Adaptor System (FIG. 1 Item 32) that consists of a plurality of battery types and sizes and a current control system that would control the amount of current that would flow out to the PETLS B-Book; and

a Battery Charging System (FIG. 1 Item 33) that would recharge the batteries in the PETLS B-Book; and

a plurality of energy sources including a wall electrical outlet (FIG. 1 Item 31), a solar energy system (FIG. 1 Item 34), or a hydro energy system (FIG. 1 Item 35) and the like, that would be suitable to charge and recharge the batteries in the battery adaptor system.

Using the Personal Electronic Text Library System

Operation of the PETLS Distribution Center:

The first step in using the Personal Electronic Library System [PETLS] would be to register publishers and/or other sources of text book and/or printed material [herein referred to as “Publisher et. al.”] with the PETLS Distribution Center. To register “Publisher et. al.” will connect to the PETLS Distribution Center through the on-line website, and fill out the registration form. Once the registration has been approved, the PETLS Distribution Center will assign unique Publisher Identification and Protection Codes to each “Publisher et. al.”.

Prior to sending text book and/or printed material in electronic format to the PETLS Distribution Center, a “Publisher et. al.” will first apply protection to said material to protect said material against unauthorized access and/or duplication utilizing the previously assigned Publisher Identification and Protection Codes according to the proprietary and confidential PETLS Protection Standard.

Once protected text book and/or printed material in electronic format is received by the PETLS Distribution Center, the “Publisher et. al.” applied protection is replaced with an internal PETLS protection implementation. This PETLS protected text book and/or printed material in electronic format is then stored in a permanent memory storage means, such as a server or group of servers or alike, indexed and cross-referenced as appropriate. A Master List of the titles of all text book and/or printed material in electronic format stored is updated as required; this list need not be protected during storage and/or transmission.

Before Retail Access Terminals can access text book and/or printed material in electronic format stored within the PETLS Distribution Center they must be registered. To register a Retail Access Terminal will connect to the PETLS Distribution Center through the on-line website, and fill out the registration form. Once the registration has been approved, the PETLS Distribution Center will assign unique Retail Terminal Access Identification and Protection Codes to each Retail Access Terminal. The PETLS Distribution Center maintains a record of the physical locations of all the registered Retail Access Terminals which can be accessed by the consumers; this list need not be protected during storage and/or transmission.

A Retail Access Terminal can request a copy of the Master List of titles available, and using a secured sales transaction sequence incorporating the Retail Terminal Access Code can request a copy of the selected text book and/or printed material in electronic format. Additional protection may be added to the already protected material utilizing the uniquely assigned Retail Access Terminal Protection Code before transmission of said material from the PETLS Distribution Center to the requesting Retail Access Terminal.

The PETLS Distribution Center also maintains a plurality of sales accounting records each being specific to the each “Publisher et. al.” As sales of text book and/or printed material in electronic format are confirmed, the sales accounting record for the “Publisher et. al.” originally providing said material is updated for royalty calculation purposes. Periodically copies of the sales accounting records are forwarded to their respective “Publisher et. al.”

The PETLS Distribution Center also monitors the status of the registered Retail Access Terminals as a background activity and can upgrade the software resident on a Retail Access Terminal as and when required.

Operation of the Retail Access Terminals:

The first step in accessing text book and/or printed material in electronic format from the PETLS Distribution Center is to download a copy of the Master List of all available material.

Once a selection is made, a secured sales transaction sequence is initiated comprising the steps of:

Sending a request containing the title of the material requested and verification of payment for same along with the uniquely assigned Retail Access Terminal Identification Code to the PETLS Distribution Center,

After authorization of the requesting Retail Access Terminal, the PETLS Distribution Center will transmit a copy of the protected text book and/or printed material in electronic format to the temporary storage means within the Retail Access Terminal using a secured transfer protocol,

Next a PETLS Electronic Storage Media is inserted into an appropriate storage media reader slot in the Retail Access Terminal and is verified as such,

Then a write process is initiated wherein the text book and/or printed material in electronic format stored within the temporary storage means is then written onto the secured access portion of the PETLS Electronic Storage Media in a secured protected manner in conjunction with proprietary hardware and/or software embedded within the PETLS Electronic Storage Media and the Retail Access Terminal,

Upon verification of a successful write process the temporary storage means is cleared of all text book and/or printed material in electronic format, otherwise the write process is repeated as required, and

Finally, a message is sent to the PETLS Distribution Center signalling the successful completion of a sales transaction sequence.

PETLS B-Book Operation:

The PETLS B-Book operation of displaying the text book and/or printed material in electronic format protected against unauthorized duplication from the secured access portion of a PETLS Electronic Storage Media comprises the steps of:

A first step of inserting a PETLS Electronic Storage Media into a corresponding media reader means in the B-Book,

A second step wherein a process in the B-Book embedded software is executed which verifies that said media is a valid PETLS Electronic Storage Media,

Another step wherein another process in the B-Book embedded software is executed which accesses a page (or two pages depending on the User selected display mode) of said material from the secured access portion of the PETLS Electronic Storage Media using a secured transaction means between proprietary hardware and/or software embedded on the PETLS Electronic Storage Media and complementary proprietary hardware and/or software embedded in the B-Book,

Another step wherein this page (or two pages) of text book and/or printed material still being protected against unauthorized duplication is temporarily stored in the temporary memory storage means embedded in the B-Book,

A subsequent step wherein a process in the B-Book embedded software is executed which un-locks said page (or two pages) of said material for the purpose of display on the B-Book display device which is then stored in the temporary memory storage means embedded in the B-Book,

Yet a further step wherein said page (or two pages) of un-locked material is displayed on the display means of the B-Book according to the User selected single page display mode or split screen (dual page) display mode, and

Still yet a further step wherein upon User input selection of another page (or two pages) of text book and/or printed material in electronic format is recognized by yet another process of the B-Book embedded software, the sequence for accessing, un-locking and displaying said requested material is repeated.

The above mentioned steps in displaying a page (or two pages) of text book and/or printed material in electronic format occur unbeknownst (are transparent) to the User.

It should be noted that the un-locked page (or two pages) of accessed text book and/or printed material in electronic format is (are) maintained in the temporary memory storage means embedded of the B-Book only during display of said material; once display of said material is terminated, by the User requesting display of further material and/or by the User terminating B-Book operation, said material is deleted from said temporary memory storage means.

It should also be noted that proprietary hardware embedded within the B-Book is used in conjunction with the embedded software to effect the means of accessing printed material in electronic format protected against unauthorized duplication and un-locking said material to be displayed as per User input.

It should be further noted that an additional level of protection can be applied to the text book and/or other printed material in electronic format wherein such a further level of protection incorporates the unique PETLS assigned serial/registration number.

The operations of accepting User created notes, reviews, and the like and/or storage of said notes to the unsecured access portion of the PETLS Electronic Storage Media and/or transmission of said notes via infrared communication or the like to external printing and/or storage devices are managed by yet additional processes within the embedded software.

Additional operations invoked by User input accessing features provided by the B-Book are managed by other processes within the embedded software.

Many modifications and variations of the PETLS invention may be made without departing from the scope and spirit of the variations set forth herein. As is apparent from the description of the various embodiments wherein common functional elements are shared, these elements are not to be construed in a limiting sense as applying to only a single embodiment.

While only a few embodiments have been illustrated and described, many variations may be made in the design and configuration without departing from the scope of the invention as set forth in the appended claims.

We claim:

1. A method and implementation for protecting text book and/or printed material in electronic format stored on portable physical media against unauthorized duplication wherein:
said material on said portable physical media can be purchased and/or shared and/or lent and/or traded and/or donated by and/or between any and/or all individuals and/or all users of dedicated display devices displaying said material.

2. A method and implementation for protecting text book and/or printed material in electronic format stored on portable physical media against unauthorized duplication as claimed in claim 1 wherein:
said material on said portable physical media can be purchased and/or shared and/or lent and/or traded and/or donated by and/or between any and/or all individuals within authorized groups of users of dedicated display devices displaying said material.

3. A method and implementation for protecting text book and/or printed material in electronic format stored on portable physical media against unauthorized duplication as claimed in claim 1 wherein:
said material on said portable physical media is accessible only to specifically authorized individual users of dedicated display devices displaying said material.

4. A method and implementation for protecting text book and/or printed material in electronic format against unauthorized duplication as claimed in claim 1, including but not limited to:
protection of text book and/or printed material in electronic format while stored on portable physical media; and
protection of text book and/or printed material in electronic format stored on portable physical media up to the point of display of said material on dedicated display devices.

5. A method and implementation of a system of components including both hardware and software for protecting text book and/or printed material in electronic format as claimed in claim 1, during the collection, storage, distribution and access for the purpose of display of said material herein referred to as the Personal Electronic Text Library System [PETLS] wherein:
said protection of text book and/or printed material in electronic format is applied to said material entered into, stored within and transferred between components of PETLS.

6. A method and implementation of means and/or mechanisms for protecting text book and/or printed material in electronic format against unauthorized duplication as claimed in claim 1 according to a proprietary PETLS Protection Standard comprising but not limited to:
single and/or multiple levels of protection utilizing unique PETLS assigned codes and/or the like; and
proprietary hardware and/or software means to effect said single and/or multiple levels of protection.

7. A method and implementation of PETLS as claimed in claim 5 comprising but not limited to components:
a plurality of dedicated display devices for displaying the text book and/or printed material in electronic format protected against unauthorized duplication from a plurality of portable physical media;
a plurality of portable physical media for storing text book and/or printed material in electronic format protected against unauthorized duplication;
a plurality of points of access of the plurality of text book and/or printed material in electronic format protected against unauthorized duplication stored within PETLS; and
a repository for the storage of the collection of a plurality of text book and/or printed material in electronic format protected against unauthorized duplication from a plurality of sources of said material.

8. A plurality of dedicated display devices herein referred to as B-Books as claimed in claim 1 wherein B-Books are the only component of PETLS capable of displaying text book and/or printed material in electronic format protected against unauthorized duplication.

9. A plurality of portable physical media for storing text book and/or printed material in electronic format protected against unauthorized duplication herein referred to as the PETLS Electronic Storage Media as claimed in claim 1 wherein:
text book and/or printed material in electronic format stored on the PETLS Electronic Storage Media is protected against unauthorized duplication according to the proprietary PETLS Protection Standard;
the PETLS Electronic Storage Media is the only means of entering text book and/or printed material in electronic format protected against unauthorized duplication into the plurality of B-Book dedicated display devices; and
the PETLS Electronic Storage Media can be purchased and/or shared and/or lent and/or traded and/or donated by and/or between any and/or all individuals and/or all users of dedicated display devices for displaying text book and/or printed material in electronic format without compromising protection against unauthorized duplication.

10. A means and implementation of the secured transfer of text book and/or printed material in electronic format protected against unauthorized duplication as said material is transferred through the plurality of points of access as claimed in claim 7, herein referred to as the Retail Access Terminals, to one of a plurality of portable PETLS Electronic Storage Media, the transfer of said material comprises but is not limited to steps wherein:
text book and/or printed material in electronic format protected from unauthorized duplication is transferred from the repository of said material to each of the plurality of Retail Access Terminals;
said material is temporarily stored in the temporary memory storage means of each of the plurality of Retail Access Terminals;
said temporarily stored material is then written onto one of a plurality of portable PETLS Electronic Storage Media; and
said temporarily stored material then being deleted from the temporary memory storage means of each of the plurality of Retail Access Terminals.

11. A means and implementation for protecting text book and/or printed material in electronic format during the transfer into, the storage within and the transfer from the repository of said material within PETLS as claimed in claim 7 herein referred to as the PETLS Distribution Center wherein:
the plurality of text book and/or printed material in electronic format from a plurality of sources of said material is protected from unauthorized duplication during the transfer of said material into the PETLS Distribution Center;
said material is further protected against unauthorized duplication prior to storage of said material within the PETLS Distribution Center;
copies of the said further protected material stored within the PETLS Distribution Center are transferred in a means and manner to yet further protect said material from unauthorized duplication to each of the plurality of Retail Access Terminals so requesting said material.

12. A means and implementation for protection against unauthorized duplication of text book and/or printed material in electronic format from a plurality of sources of said material according to the PETLS Protection Standard as claimed in claim 6 comprising but not limited to:
protection of said material transferred from the plurality of sources of said material in electronic format into PETLS utilizing PETLS assigned Publisher Identification and Protection Codes and/or the like wherein each of the plurality of sources of said material is assigned a unique individual Publisher Identification and Protection Code and/or the like; and
wherein said material in electronic format protected against unauthorized duplication from one of the plurality of sources of said material can not be displayed and/or otherwise accessed by any of the other sources of said material.

13. A means and implementation for protection against unauthorized duplication for text book and/or printed material in electronic format stored within the PETLS Distribution Center as claimed in claim 11 wherein:
each original version of the text book and/or printed material in electronic format stored within PETLS is protected against unauthorized duplication utilizing unique PETLS assigned Key Codes, serial/registration numbers or alike according to the PETLS Protection Standard; and
said material thus protected can only be displayed on dedicated B-Book display devices.

14. A means and implementation for protection against unauthorized duplication for text book and/or printed material in electronic format transferred from the PETLS Distribution Center to each of the plurality of Retail Access Terminals claimed in claim 10 according to the PETLS Protection Standard comprising but not limited to:
protection of said material protected from unauthorized duplication utilizing PETLS assigned Retail Access Terminal Identification and Protection Codes and/or the like wherein each of the plurality of Retail Access Terminals is assigned a unique Retail Access Terminal Identification and Protection Code and/or the like; and
wherein the said material protected against unauthorized duplication transferred from the PETLS Distribution Center to a specific Retail Access Terminal so requesting said material can not be accessed by any other of the plurality of Retail Access Terminals.

15. A method and implementation for further protection means of text book and/or printed material in electronic format protected against unauthorized duplication as said material is written to and stored on the PETLS Electronic Storage Media as claimed in claim 7 according to the PETLS Protection Standard comprising but not limited to:
a portion of each of the plurality of PETLS Electronic Storage Media herein referred to as the “secured access portion”;
wherein the further protection means of said material utilizes PETLS proprietary hardware and/or software or alike incorporated and/or resident on each of the plurality of PETLS Electronic Storage Media;
wherein the further protection means of said material utilizes PETLS proprietary hardware and/or software or alike incorporated and/or resident on each of the plurality of Retail Access Terminals;
and wherein said further protection of said material during writing and storage of said material from each of a plurality of Retail Access Terminal onto each of a plurality of PETLS Electronic Storage Media utilizes the PETLS proprietary hardware and/or software or alike incorporated and/or resident on both the PETLS Electronic Storage Media and the Retail Access Terminal in a prescribed manner; and
said further protection being applied only to text book and/or printed material in electronic format protected against unauthorized duplication written onto and stored within the “secured access portion” of each of the plurality of PETLS Electronic Storage Media.

16. A method and implementation of access means for B-Book access of the further protected text book and/or printed material in electronic format protected against unauthorized duplication stored within the “secured access portion” of each of the plurality of PETLS Electronic Storage Media by the further protection means as claimed in claim 15 comprising but not limited to:
wherein the access means of said material utilizes PETLS proprietary hardware and/or software or alike incorporated and/or resident on each of the plurality of PETLS Electronic Storage Media;
wherein the access means of said material utilizes PETLS proprietary hardware and/or software or alike incorporated and/or resident on each of the plurality of B-Books;
wherein the access means of said material during access of said material by each of the plurality of B-Books from the “secured access portion” of said media utilizes the PETLS proprietary hardware and/or software or alike incorporated and/or resident on both the PETLS Electronic Storage Media and the B-Book in a prescribed manner; and
said access means being applied only to further protected text book and/or printed material in electronic format protected against unauthorized duplication accessed from the “secured access portion” of each of the plurality of PETLS Electronic Storage Media.

17. A method and implementation for protecting text book and/or printed material in electronic format stored on portable physical media against unauthorized duplication as claimed in claim 1 wherein:
said protection is applied to copyrighted text book and/or printed material in electronic format;
said protection is applied to non-copyrighted but economically valuable text book and/or printed material in electronic format; and
said protection is applied to other types of non-copyrighted text book and/or printed material in electronic format.

18. A means and implementation for B-Book Users to create notes, reviews, and the like, to store said notes in an “unsecured access portion” of each of a plurality of PETLS Electronic Storage Media and/or to transmit said notes via an infrared means or the like to an external device so equipped to receive said transmissions wherein such a said device consists of one of a plurality of Retail Access Terminals, dedicated printers, personal computers or the like.

19. A means and implementation for protecting text book and/or printed material in electronic format against unauthorized duplication as said material is transferred between components of PETLS over each of the plurality of transmission media and/or means consisting of but not limited to wired, wire-less, optical, satellite and/or the like.

20. A means and implementation for protecting text book and/or printed material in electronic format from a plurality of sources of said material to a plurality of users of said material on each of a plurality of portable PETLS Electronic Storage Media.
